(19) United States
(12) Patent Application Publication
(10) Pub. No.: US 2008/0021660 A1
(43) Pub. Date: Jan. 24, 2008

(54) Method and system for visualizing common aberrations from multi-sample comparative genomic hybridization data sets

(76) Inventors: Amitabh Shukla, San Jose, CA (US); Amir Ben-dor, Bellevue, WA (US); Jayati Ghosh, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/492,377

(22) Filed: Jul. 24, 2006

(51) Int. Cl. G06F 19/00

(52) U.S. Cl. 702/20

(57) ABSTRACT

A computer-implemented method for viewing comparative genomic hybridization (CGH) data is provided. In certain embodiments, the method comprises: a) inputting a plurality of CGH data sets for a corresponding plurality of genomic samples into a computer memory; b) analyzing the CGH data sets using an aberration calling method to identify chromosomal regions having aberrant copy number; and c) producing a graphical user interface that shows graphical representations of a chromosomes from each of the genomic samples.

### BACKGROUND

The present invention is related to analysis of comparative genomic hybridization data, and, in particular, to various method and system embodiments for detecting and visualizing aberrations that are common to multiple samples from which the comparative genomic hybridization data has been obtained.

### SUMMARY OF THE INVENTION

A computer-implemented method for viewing comparative genomic hybridization (CGH) data is provided. In certain embodiments, the method comprises: a) inputting a plurality of CGH data sets for a corresponding plurality of genomic samples into a computer memory; b) analyzing the CGH data sets using an aberration calling method to identify chromosomal regions having aberrant copy number; and c) producing a graphical user interface that shows graphical representations of a chromosomes from each of the genomic samples. The graphical representations show the chromosomal regions having aberrant copy number. The graphical representations may be aligned adjacent to each other. The method may further comprise executing instructions to identify chromosomal regions having aberrant copy number that are common the selected chromosome. The common aberrant copy number regions may be indicated on the graphical representations.

### BRIEF DESCRIPTION OF THE DRAWINGS

The patent or application file contains at least one drawing executed in color. Copies of this patent application publication with color drawing(s) will be provided by the U.S. Patent and Trademark Office upon request and payment of the necessary fee

FIG. 1 shows the chemical structure of a small, four-subunit, single-chain oligonucleotide.

FIG. 2 shows a symbolic representation of a short stretch of double-stranded DNA.

FIG. 3 illustrates construction of a protein based on the information encoded in a gene.

FIG. 4 shows a hypothetical set of chromosomes for a very simple, hypothetical organism.

FIG. 5 shows examples of gene deletion and gene amplification in the context of the hypothetical genome shown in FIG. 4.

FIGS. 6-7 illustrate detection of gene amplification by CGH.

FIGS. 8-9 illustrate detection of gene deletion by CGH.

FIGS. 10-12 illustrate microarray-based CGH.

FIG. 13 illustrates one method for identifying and ranking intervals and removing redundancies from lists of intervals identified as probable deletions or amplifications.

FIG. 14 illustrates the general problem domain to which method and system embodiments of the present invention are directed.

FIGS. 15A-B illustrate an aberrant interval within a chromosome.

FIGS. 16A-B illustrate a set of aberrant intervals associated with a particular chromosome or genome.

FIG. 17 illustrates, using the illustration conventions previously used in FIG. 14, a data set resulting from CGH or aCGH analysis of each of n samples S₁-Sₙ of a multi-sample CGH or aCGH data set.

FIGS. 18A-E illustrate selection of a set of candidate intervals with respect to a multi-sample CGH or aCGH data set, for each sample of which aberrant intervals have been identified.

FIG. 19 shows an illustration of the per-sample statistical scores generated for each candidate-interval/sample pair.

FIGS. 20A-B illustrate computation of a context-based statistical score.

FIG. 21 illustrates computation of a cumulative significance score for each candidate interval.

FIG. 22 illustrates remaining steps, following preparation of the 2-dimensional arrays of per-sample statistical scores discussed with reference to FIG. 19, of a process for identifying statistically significant candidate intervals that represents on embodiment of the present invention.

FIGS. 23A-B shows a t-test probability distribution ƒ(t).

FIG. 24 illustrates an alternative method for computing a cumulative significance score for a candidate interval.

FIGS. 25A-F show control-flow diagrams that illustrate a number of steps in various embodiments of the present invention.

FIGS. 26-30 are screenshots illustrating several features of certain computer-implemented viewing methods described in greater detail below.

### DETAILED DESCRIPTION OF THE INVENTION

A computer-implemented method for viewing comparative genomic hybridization (CGH) data is provided. In certain embodiments, the method comprises: a) inputting a plurality of CGH data sets for a corresponding plurality of genomic samples into a computer memory; b) analyzing the CGH data sets using an aberration calling method to identify chromosomal regions having aberrant copy number; and c) producing a graphical user interface that shows graphical representations of a chromosomes from each of the genomic samples. The graphical representations show the chromosomal regions having aberrant copy number. The graphical representations may be aligned adjacent to each other. The method may further comprise executing instructions to identify chromosomal regions having aberrant copy number that are common the selected chromosome. The common aberrant copy number regions may be indicated on the graphical representations.

Embodiments of the present invention employ automated detection of aberrations common to multiple samples within a multi-sample comparative genomic hybridization (“CGH”) or an array-based CGH (“aCGH”) data set. Commonly, CGH and aCGH data sets are analyzed using aberration-calling methods in order to determine those array-probe-complementary chromosome subsequences that have abnormal copy numbers with respect to a control genome. Abnormal copy numbers may include amplification of chromosome subsequences and deletion of chromosome subsequences with respect to a normal genome, or to increased or decreased copies of entire chromosomes. In a first subsection, below, a discussion of array-based comparative genomic hybridization methods and interval-based aberration-calling methods for analyzing aCGH data sets is provided. In a second subsection, embodiments of the present invention are discussed. When the term acronym CGH is used without being paired with the acronym aCGH in the following discussion, CGH is meant to include both traditional comparative genomic hybridization as well as array-based comparative genomic hybridization.

### Array-Based Comparative Genomic Hybridization and Interval-Based aCGH Data Analysis

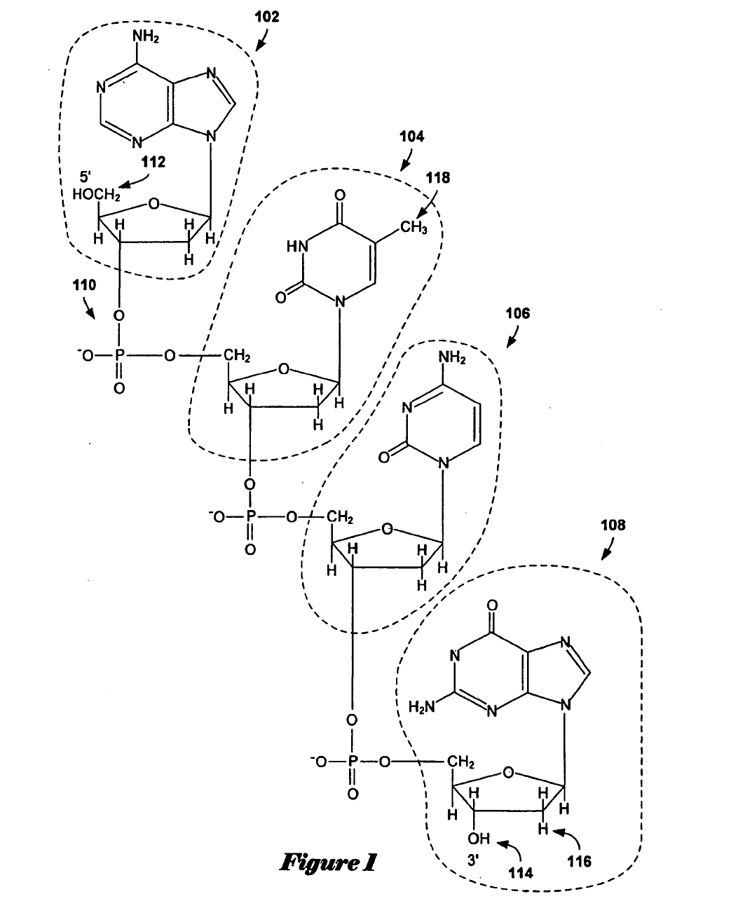

Prominent information-containing biopolymers include deoxyribonucleic acid (“DNA”), ribonucleic acid (“RNA”), including messenger RNA (“mRNA”), and proteins. FIG. 1 shows the chemical structure of a small, four-subunit, single-chain oligonucleotide, or short DNA polymer. The oligonucleotide shown in FIG. 1 includes four subunits: (1) deoxyadenosine 102, abbreviated “A”; (2) deoxythymidine 104, abbreviated “T”; (3) deoxycytodine 106, abbreviated “C”; and (4) deoxyguanosine 108, abbreviated “G.” Each subunit 102, 104, 106, and 108 is generically referred to as a “deoxyribonucleotide,” and consists of a purine, in the case of A and G, or pyrimidine, in the case of C and T, covalently linked to a deoxyribose. The deoxyribonucleotide subunits are linked together by phosphate bridges, such as phosphate 110. The oligonucleotide shown in FIG. 1, and all DNA polymers, is asymmetric, having a 5′ end 112 and a 3′ end 114, each end comprising a chemically active hydroxyl group. RNA is similar, in structure, to DNA, with the exception that the ribose components of the ribonucleotides in RNA have a 2′ hydroxyl instead of a 2′ hydrogen atom, such as 2′ hydrogen atom 116 in FIG. 1, and include the ribonucleotide uridine, similar to thymidine but lacking the methyl group 118, instead of a ribonucleotide analog to deoxythymidine. The RNA subunits are abbreviated A, U, C, and G.

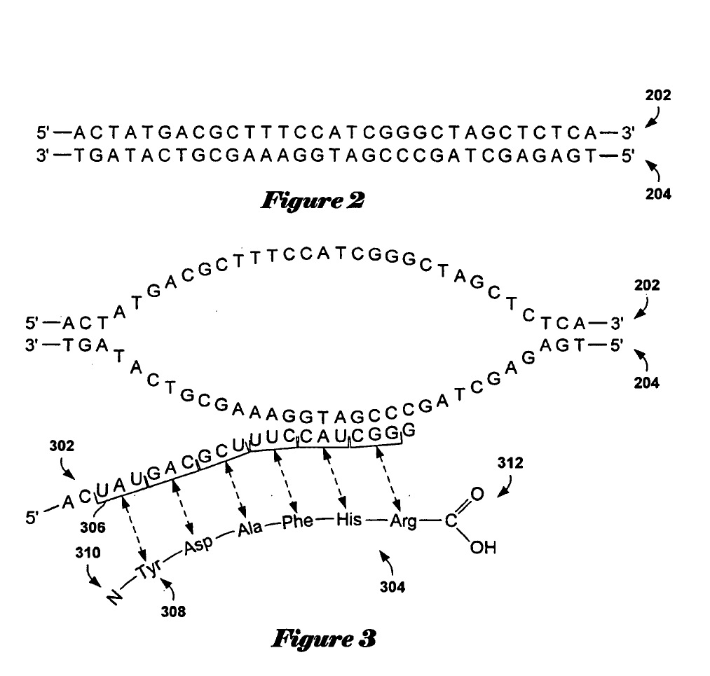

In cells, DNA is generally present in double-stranded form, in the familiar DNA-double-helix form. FIG. 2 shows a symbolic representation of a short stretch of double-stranded DNA. The first strand 202 is written as a sequence of deoxyribonucleotide abbreviations in the 5′ to 3′ direction and the complementary strand 204 is symbolically written in 3′ to 5′ direction. Each deoxyribonucleotide subunit in the first strand 202 is paired with a complementary deoxyribonucleotide subunit in the second strand 204. In general, a G in one strand is paired with a C in a complementary strand, and an A in one strand is paired with a T in a complementary strand. One strand can be thought of as a positive image, and the opposite, complementary strand can be thought of as a negative image, of the same information encoded in the sequence of deoxyribonucleotide subunits.

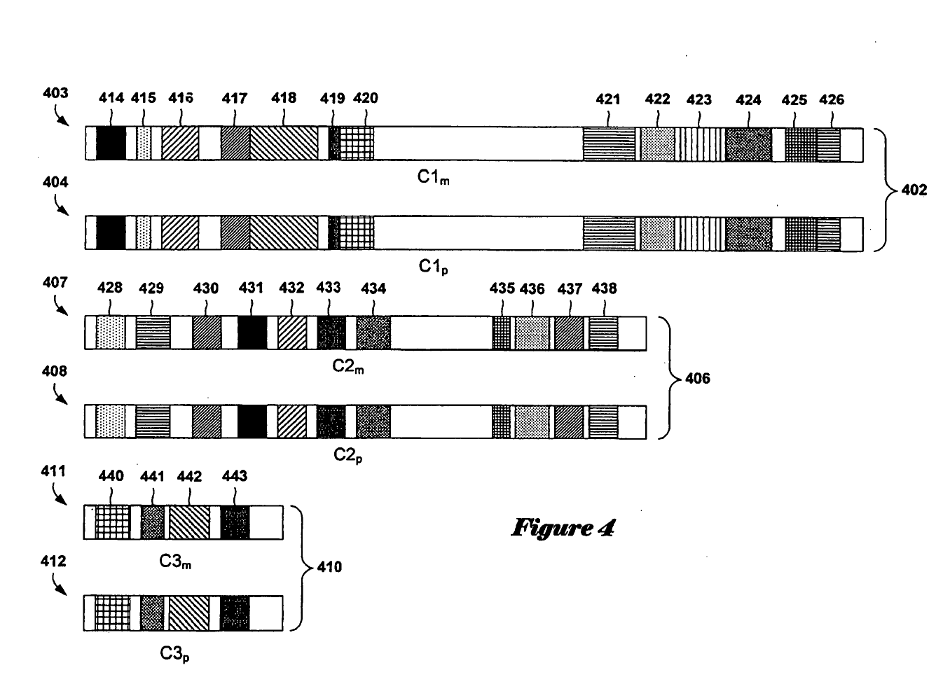

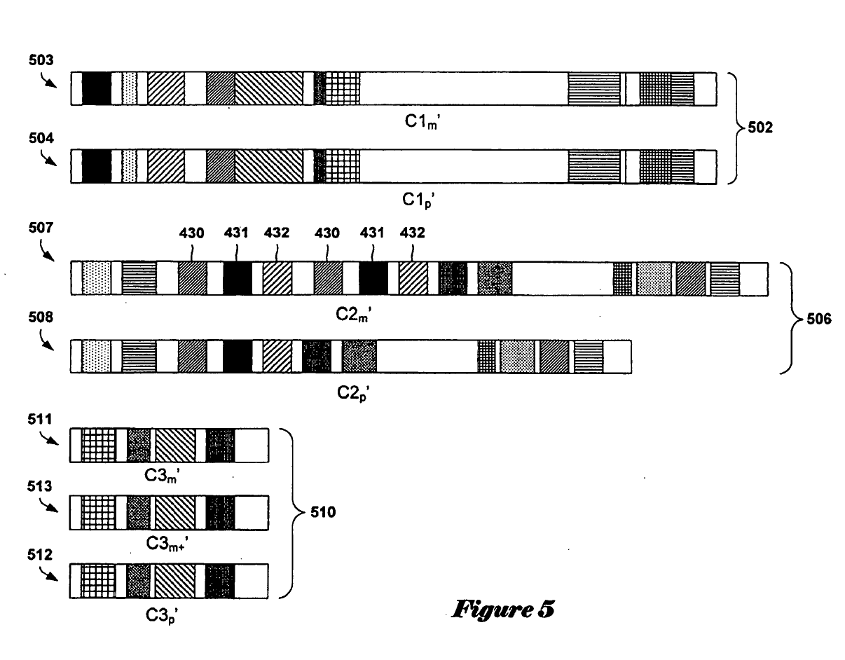

A gene is a subsequence of deoxyribonucleotide subunits within one strand of a double-stranded DNA polymer. One type of gene can be thought of as an encoding that specifies, or a template for, construction of a particular protein. FIG. 3 illustrates construction of a protein based on the information encoded in a gene. In a cell, a gene is first transcribed into single-stranded mRNA. In FIG. 3, the double-stranded DNA polymer composed of strands 202 and 204 has been locally unwound to provide access to strand 204 for transcription machinery that synthesizes a single-stranded mRNA 302 complementary to the gene-containing DNA strand. The single-stranded mRNA is subsequently translated by the cell into a protein polymer 304, with each three-ribonucleotide codon, such as codon 306, of the mRNA specifying a particular amino acid subunit of the protein polymer 304. For example, in FIG. 3, the codon “UAU” 306 specifies a tyrosine amino-acid subunit 308. Like DNA and RNA, a protein is also asymmetrical, having an N-terminal end 310 and a carboxylic acid end 312. Other types of genes include genomic subsequences that are transcribed to various types of RNA molecules, including catalytic RNAs, iRNAs, siRNAs, rRNAs, and other types of RNAs that serve a variety of functions in cells, but that are not translated into proteins. Furthermore, additional genomic sequences serve as promoters and regulatory sequences that control the rate of protein-encoding-gene expression. Although functions have not, as yet, been assigned to many genomic subsequences, there is reason to believe that many of these genomic sequences are functional. For the purpose of the current discussion, a gene can be considered to be any genomic subsequence.

In eukaryotic organisms, including humans, each cell contains a number of extremely long, DNA-double-strand polymers called chromosomes. Each chromosome can be thought of, abstractly, as a very long deoxyribonucleotide sequence. Each chromosome contains hundreds to thousands of subsequences, many subsequences corresponding to genes. The exact correspondence between a particular subsequence identified as a gene, in the case of protein-encoding genes, and the protein or RNA encoded by the gene can be somewhat complicated, for reasons outside the scope of the present invention. However, for the purposes of describing embodiments of the present invention, a chromosome may be thought of as a linear DNA sequence of contiguous deoxyribonucleotide subunits that can be viewed as a linear sequence of DNA subsequences. In certain cases, the subsequences are genes, each gene specifying a particular protein or RNA. Amplification and deletion of any DNA subsequence or group of DNA subsequences can be detected by comparative genomic hybridization, regardless of whether or not the DNA subsequences correspond to protein-sequence-specifying genes, to DNA subsequences specifying various types of RNAs, or to other regions with defined biological roles. The term “gene” is used in the following as a notational convenience, and should be understood as simply an example of a “biopolymer subsequence.” Similarly, although the described embodiments are directed to analyzing DNA chromosomal subsequences extracted from diseased tissues for amplification and deletion with respect to control tissues, the sequences of any information-containing biopolymer are analyzable by methods of the present invention. Therefore, the term “chromosome,” and related terms, are used in the following as a notational convenience, and should be understood as an example of a biopolymer or biopolymer sequence. In summary, a genome, for the purposes of describing the present invention, is a set of sequences. Genes are considered to be subsequences of these sequences. Comparative genomic hybridization techniques can be used to determine changes in copy number of any set of genes of any one or more chromosomes in a genome.

FIG. 4 shows a hypothetical set of chromosomes for a very simple, hypothetical organism. The hypothetical organism includes three pairs of chromosomes 402, 406, and 410. Each chromosome in a pair of chromosomes is similar, generally having identical genes at identical positions along the lines of the chromosome. In FIG. 4, each gene is represented as a subsection of the chromosome. For example, in the first chromosome 403 of the first chromosome pair 402, 13 genes are shown, 414-426.

As shown in FIG. 4, the second chromosome 404 of the first pair of chromosomes 402 includes the same genes, at the same positions, as the first chromosome. Each chromosome of the second pair of chromosomes 406 includes eleven genes 428-438, and each chromosome of the third pair of chromosomes 410 includes four genes 440-443. In a real organism, there are generally many more chromosome pairs, and each chromosome includes many more genes. However, the simplified, hypothetical genome shown in FIG. 4 is suitable for describing embodiments of the present invention. Note that, in each chromosome pair, one chromosome is originally obtained from the mother of the organism, and the other chromosome is originally obtained from the father of the organism. Thus, the chromosomes of the first chromosome pair 402 are referred to as chromosome “C1ₘ” and “C1ₚ.” While, in general, each chromosome of a chromosome pair has the same genes positioned at the same location along the length of the chromosome, the genes inherited from one parent may differ slightly from the genes inherited from the other parent. Different versions of a gene are referred to as alleles. Common differences include single-deoxyribonucleotide-subunit substitutions at various positions within the DNA subsequence corresponding to a gene. Less frequent differences include translocations of genes to different positions within a chromosome or to a different chromosome, a different number of repeated copies of a gene, and other more substantial differences.

Although differences between genes and mutations of genes may be important in the predisposition of cells to various types of cancer, and related to cellular mechanisms responsible for cell transformation, cause-and-effect relationships between different forms of genes and pathological conditions are often difficult to elucidate and prove, and are very often indirect. However, other genomic abnormalities are more easily associated with pre-cancerous and cancerous tissues. Two such prominent types of genomic aberrations include gene amplification and gene deletion. FIG. 5 shows examples of gene deletion and gene amplification in the context of the hypothetical genome shown in FIG. 4. First, both chromosomes C1ₘ′ 503 and chromosome C1ₚ′ 504 of the variant, or abnormal, first chromosome pair 502 are shorter than the corresponding wild-type chromosomes C1ₘ and C1ₚ in the first pair of chromosomes 402 shown in FIG. 4. This shortening is due to deletion of genes 422, 423, and 424, present in the wild-type chromosomes 403 and 404, but absent in the variant chromosomes 503 and 504. This is an example of a double, or homozygous-gene-deletion. Small scale variations of DNA copy numbers can also exist in normal cells. These can have phenotypic implications, and can also be measured by CGH methods and analyzed by the methods of the present invention.

Generally, deletion of multiple, contiguous genes is observed, corresponding to the deletion of a substantial subsequence from the DNA sequence of a chromosome. Much smaller subsequence deletions may also be observed, leading to abnormal and often nonfunctional genes. A gene deletion may be observed in only one of the two chromosomes of a chromosome pair, in which case a gene deletion is referred to as being hemizygous.

A second chromosomal abnormality in the altered genome shown in FIG. 5 is duplication of genes 430, 431, and 432 in the maternal chromosome C2ₘ′ 507 of the second chromosome pair 506. Duplication of one or more contiguous genes within a chromosome is referred to as gene amplification. In the example altered genome shown in FIG. 5, the gene amplification in chromosome C2ₘ′ is heterozygous, since gene amplification does not occur in the other chromosome of the pair C2ₚ′ 508. The gene amplification illustrated in FIG. 5 is a two-fold amplification, but three-fold and higher-fold amplifications are also observed. An extreme chromosomal abnormality is illustrated with respect to the third chromosome pair (410 in FIG. 4). In the altered genome illustrated in FIG. 5, the entire maternal chromosome 511 has been duplicated from a third chromosome 513, creating a chromosome triplet 510 rather than a chromosome pair. This three-chromosome phenomenon is referred to as a trisomy. The trisomy shown in FIG. 5 is an example of heterozygous gene amplification, but it is also observed that both chromosomes of a chromosome pair may be duplicated, higher-order amplification of chromosomes may be observed, and heterozygous and hemizygous deletions of entire chromosomes may also occur, although organisms with such genetic deletions are generally not viable.

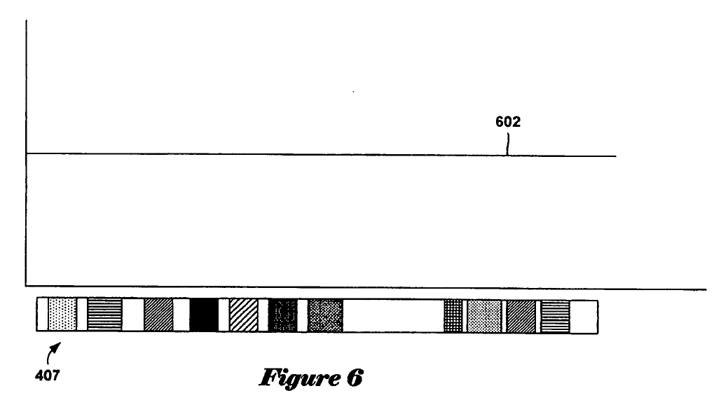

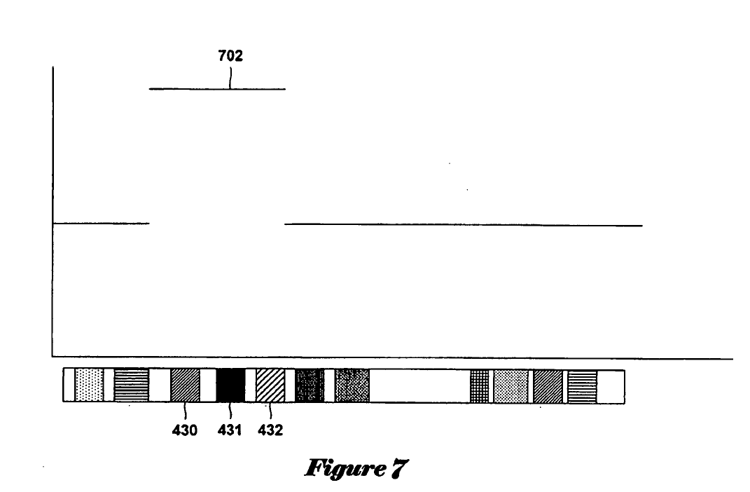

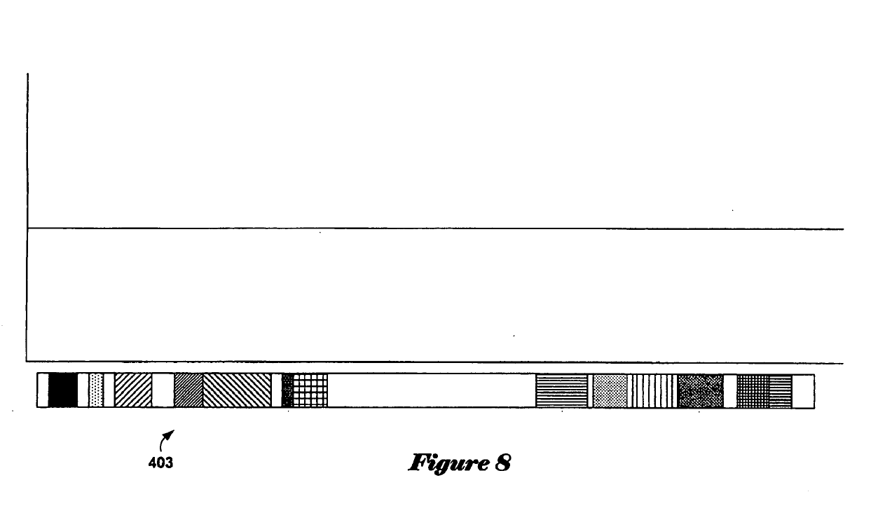

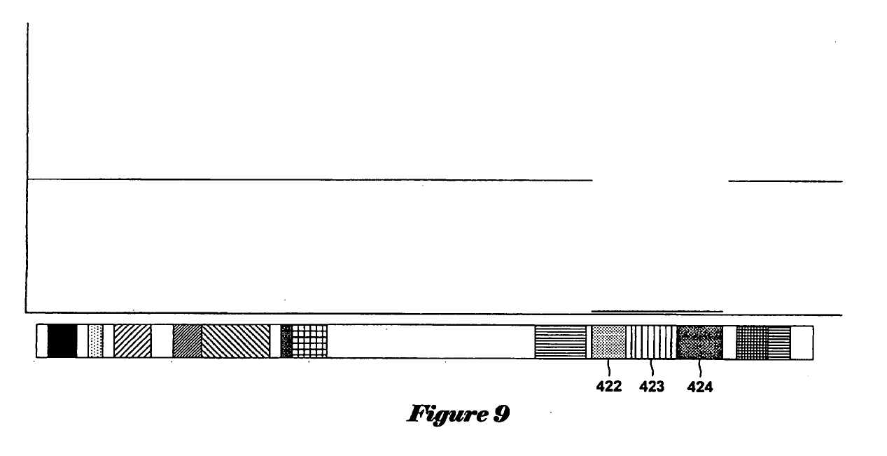

Changes in the number of gene copies, either by amplification or deletion, can be detected by comparative genomic hybridization (“CGH”) techniques. FIGS. 6-7 illustrate detection of gene amplification by CGH, and FIGS. 8-9 illustrate detection of gene deletion by CGH. CGH involves analysis of the relative level of binding of chromosome fragments from sample tissues to single-stranded, normal chromosomal DNA. The tissues-sample fragments hybridize to complementary regions of the normal, single-stranded DNA by complementary binding to produce short regions of double-stranded DNA. Hybridization occurs when a DNA fragment is exactly complementary, or nearly complementary, to a subsequence within the single-stranded chromosomal DNA. In FIG. 6, and in subsequent figures, one of the hypothetical chromosomes of the hypothetical wild-type genome shown in FIG. 4 is shown below the x axis of a graph, and the level of sample fragment binding to each portion of the chromosome is shown along the y axis. In FIG. 6, the graph of fragment binding is a horizontal line 602, indicative of generally uniform fragment binding along the length of the chromosome 407. In an actual experiment, uniform and complete overlap of DNA fragments prepared from tissue samples may not be possible, leading to discontinuities and non-uniformities in detected levels of fragment binding along the length of a chromosome. However, in general, fragments of a normal chromosome isolated from normal tissue samples should, at least, provide a binding-level trend approaching a horizontal line, such as line 602 in FIG. 6. By contrast, CGH data for fragments prepared from the sample genome illustrated in FIG. 5 should generally show an increased binding level for those genes amplified in the abnormal genotype.

FIG. 7 shows hypothetical CGH data for fragments prepared from tissues with the abnormal genotype illustrated in FIG. 5. As shown in FIG. 7, an increased binding level 702 is observed for the three genes 430-432 that are amplified in the altered genome. In other words, the fragments prepared from the altered genome should be enriched in those gene fragments from genes which are amplified. Moreover, in quantitative CGH, the relative increase in binding should be reflective of the increase in a number of copies of particular genes.

FIG. 8 shows hypothetical CGH data for fragments prepared from normal tissue with respect to the first hypothetical chromosome 403. Again, the CGH-data trend expected for fragments prepared from normal tissue is a horizontal line indicating uniform fragment binding along the length of the chromosome. By contrast, the homozygous gene deletion in chromosomes 503 and 504 in the altered genome illustrated in FIG. 5 should be reflected in a relative decrease in binding with respect to the deleted genes. FIG. 9 illustrates hypothetical CGH data for DNA fragments prepared from the hypothetical altered genome illustrated in FIG. 5 with respect to a normal chromosome from the first pair of chromosomes (402 in FIG. 4). As seen in FIG. 9, no fragment binding is observed for the three deleted genes 422; 423, and 424.

CGH data may be obtained by a variety of different experimental techniques. In one technique, DNA fragments are prepared from tissue samples and labeled with a particular chromophore. The labeled DNA fragments are then hybridized with single-stranded chromosomal DNA from a normal cell, and the single-stranded chromosomal DNA then visually inspected via microscopy to determine the intensity of light emitted from labels associated with hybridized fragments along the length of the chromosome. Areas with relatively increased intensity reflect regions of the chromophore amplified in the corresponding tissue chromosome, and regions of decreased emitted signal indicate deleted regions in the corresponding tissue chromosome. In other techniques, normal DNA fragments labeled with a first chromophore are competitively hybridized to a normal single-stranded chromosome with fragments isolated from abnormal tissue, labeled with a second chromophore. Relative binding of normal and abnormal fragments can be detected by ratios of emitted light at the two different intensities corresponding to the two different chromophore labels.

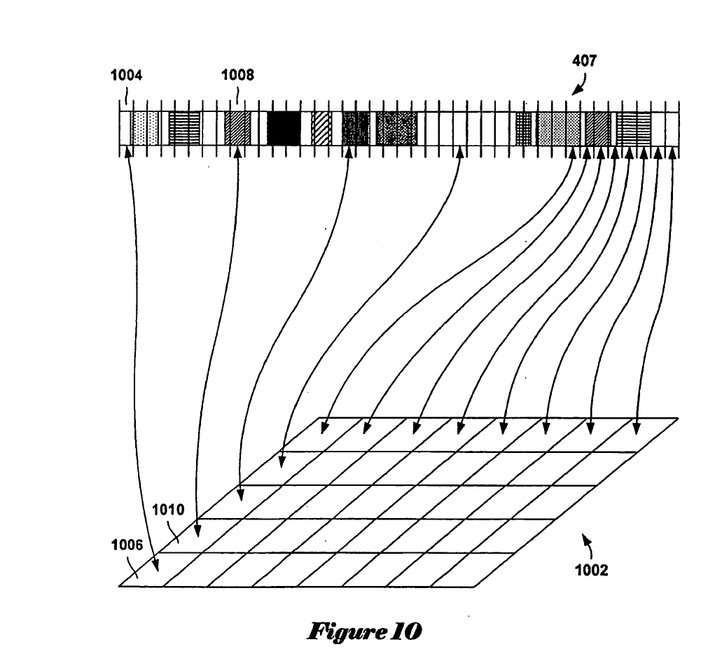

A third type of CGH is referred to as microarray-based CGH (“aCGH”). FIGS. 10-11 illustrate microarray-based CGH. In FIG. 10, synthetic probe oligonucleotides having sequences equal to contiguous subsequences of hypothetical chromosome 407 and/or 408 in the hypothetical, normal genome illustrated in FIG. 4 are prepared as features on the surface of the microarray 1002. For example, a synthetic probe oligonucleotide having the sequence of one strand of the region 1004 of chromosome 407 and/or 408 is synthesized in feature 1006 of the hypothetical microarray 1002. Similarly, an oligonucleotide probe corresponding to subsequence 1008 of chromosome 407 and 408 is synthesized to produce the oligonucleotide probe molecules of feature 1010 of microarray 1002. In actual cases, probe molecules may be much shorter relative to the length of the chromosome, and multiple, different, overlapping and non-overlapping probes/features may target a particular gene. Nonetheless, there is generally a definite, well-known correspondence between microarray features and genes, with the term “genes,” as discussed above, referring broadly to any biopolymer subsequence of interest. There are many different types of aCGH procedures, including the two-chromophore procedure described above, single-chromophore CGH on single-nucleotide-polymorphism arrays, bacterial-artificial-chromosome-based arrays, and many other types of aCGH procedures. The present invention is applicable to all aCGH variants. For each variant, data obtained by comparing signals generated by the variant with signals generated by a normal reference generally constitute a starting point for aCGH analysis. When single-dye technologies are used, multiple microarray-based procedures may be needed for aCGH analysis.

The microarray may be exposed to sample solutions containing fragments of DNA. In one version of aCGH, an array may be exposed to fragments, labeled with a first chromophore, prepared from potentially abnormal tissue as well as to fragments, labeled with a second chromophore, prepared from a normal or control tissue. The normalized ratio of signal emitted from the first chromophore versus signal emitted from the second chromophore for each feature provides a measure of the relative abundance of the portion of the normal chromosome corresponding to the feature in the abnormal tissue versus the normal tissue. In the hypothetical microarray 1002 of FIG. 10, each feature corresponds to a different interval along the length of chromosome 407 and 408 in the hypothetical wild-type genome illustrated in FIG. 4. When fragments prepared from a normal tissue sample, labeled with a first chromophore, and DNA fragments prepared from normal tissue labeled with the second chromophore, are both hybridized to the hypothetical microarray shown in FIG. 10, and normalized intensity ratios for light emitted by the first and second chromophores are determined, the normalized ratios for all features should be relatively uniformly equal to one.

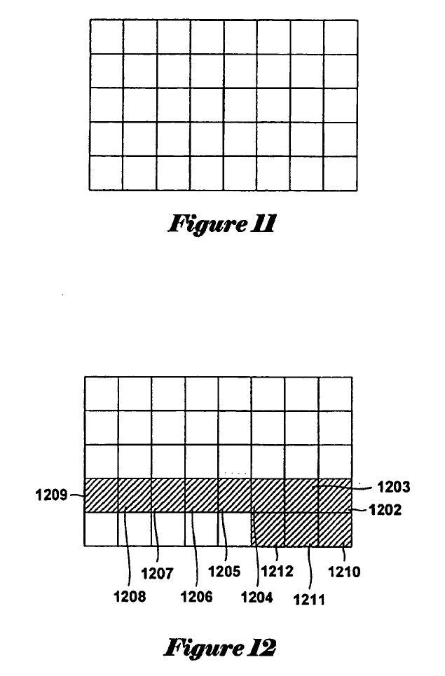

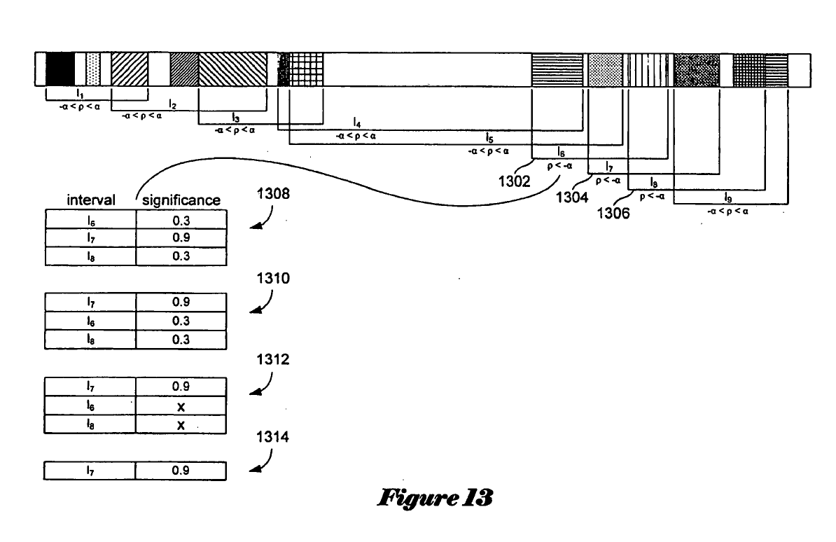

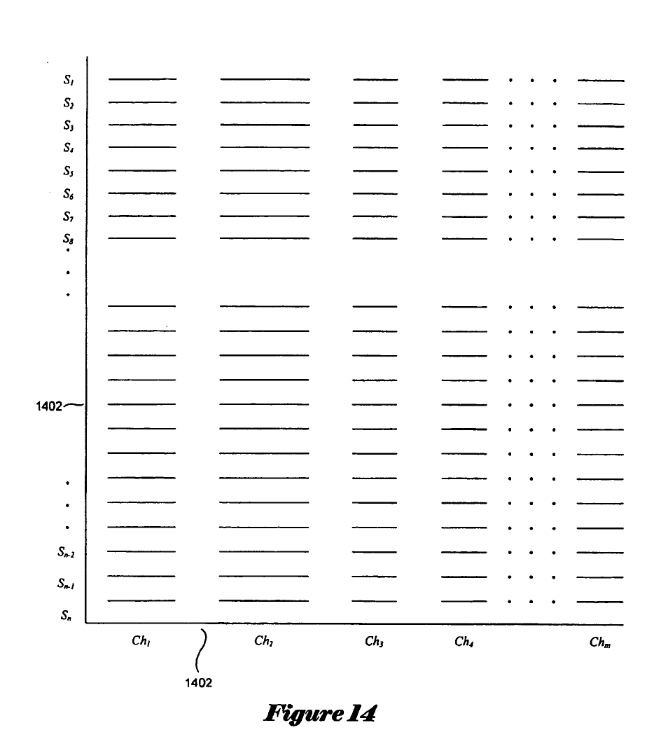

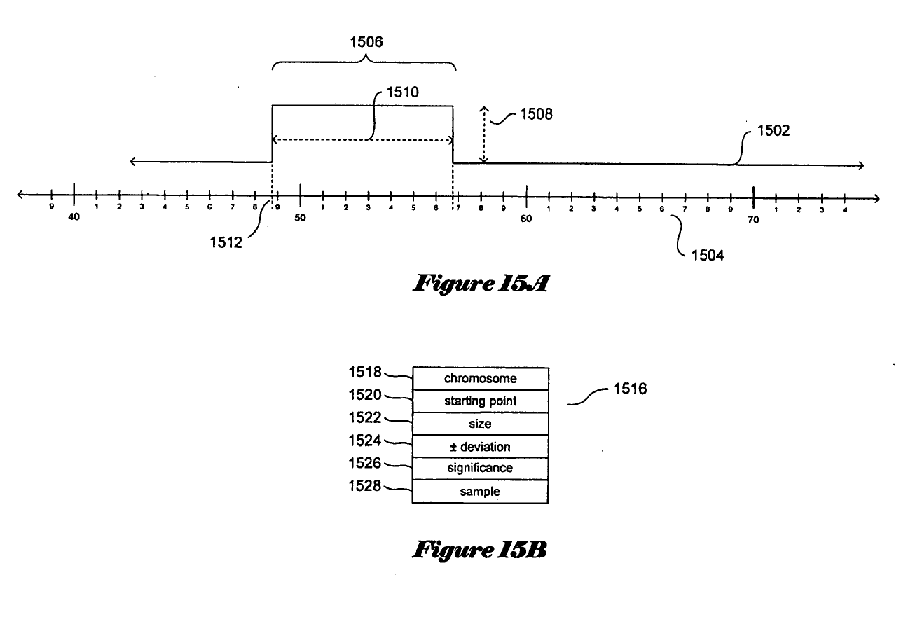

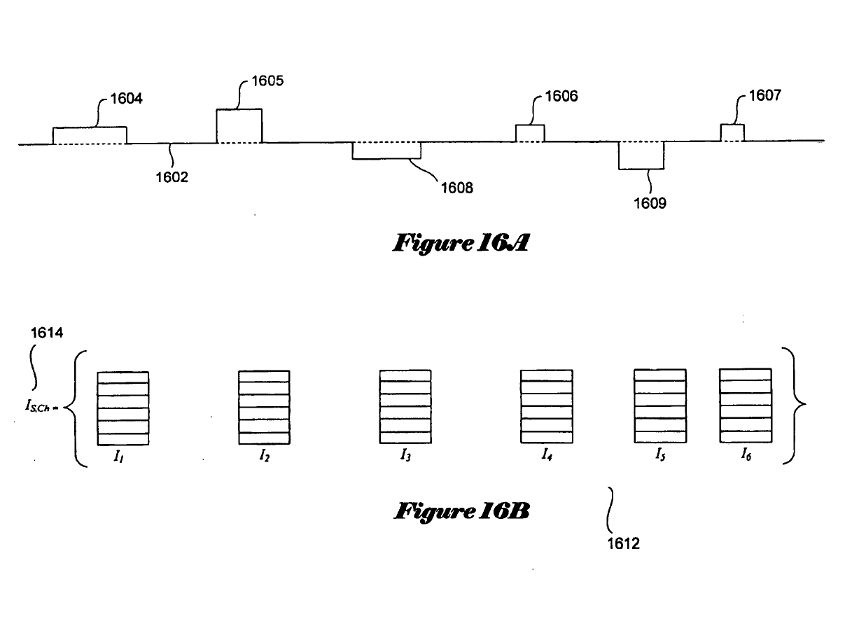

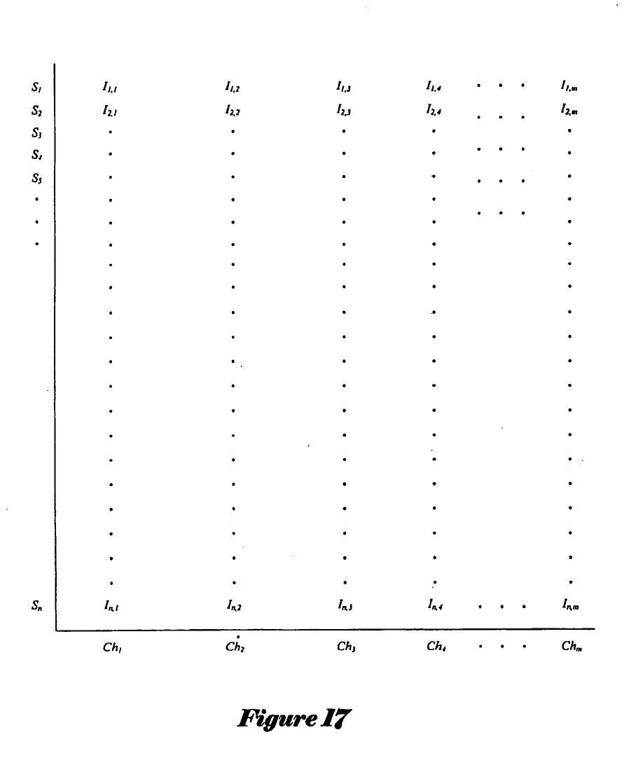

FIG. 11 represents an aCGH data set for two normal, differentially labeled samples hybridized to the hypothetical microarray shown in FIG. 10. The normalized ratios of signal intensities from the first and second chromophores are all approximately unity, shown in FIG. 11, by log ratios for all features of the hypothetical microarray 1002 displayed in the same color. By contrast, when DNA fragments isolated from tissues having the abnormal genotype, illustrated in FIG. 5, labeled with a first chromophore are hybridized to the microarray, and DNA fragments prepared from normal tissue, labeled with a second chromophore, are hybridized to the microarray, then the ratios of signal intensities of the first chromophore versus the second chromophore vary significantly from unity in those features containing probe molecules equal to, or complementary to, subsequences of the amplified genes 430, 431, and 432. As shown in FIG. 12, increase in the ratio of signal intensities from the first and second chromophores, indicated by darkened features, are observed in those features 1202-1212 with probe molecules equal to, or complementary to, subsequences spanning the amplified genes 430, 431, and 432. Similarly, a decrease in signal intensity ratios indicates gene deletion in the abnormal tissues.

Microarray-based CGH data obtained from well-designed microarray experiments provide a relatively precise measure of the relative or absolute number of copies of genes in cells of a sample tissue. Sets of aCGH data obtained from pre-cancerous and cancerous tissues at different points in time can be used to monitor genome instability in particular pre-cancerous and cancerous tissues. Quantified genome instability can then be used to detect and follow the course of particular types of cancers. Moreover, quantified genome instabilities in different types of cancerous tissue can be compared in order to elucidate common chromosomal abnormalities, including gene amplifications and gene deletions, characteristic of different classes of cancers and pre-cancerous conditions, and to design and monitor the effectiveness of drug, radiation, and other therapies used to treat cancerous or pre-cancerous conditions in patients. Unfortunately, biological data can be extremely noisy, with the noise obscuring underlying trends and patterns. Scientists, diagnosticians, and other professionals have therefore recognized a need for statistical methods for normalizing and analyzing aCGH data, in particular, and CGH data in general, in order to identify signals and patterns indicative of chromosomal abnormalities that may be obscured by noise arising from many different kinds of experimental and instrumental variations.

One approach to ameliorating the effects of high noise levels in CGH data involves normalizing sample-signal data by using control signal data. Features can be included in a microarray to respond to genome targets known to be present at well-defined multiplicities in both sample genome and the control genome. Control signal data can be used to estimate an average ratio for abnormal-genome-signal intensities to control-genome-signal intensities, and each abnormal-genome signal can be multiplied by the inverse of the estimated ratio, or normalization constant, to normalize each abnormal-genome signal to the control-genome signals. Another approach is to compute the average signal intensity for the abnormal-genome sample and the average signal intensity for the control-genome sample, and to compute a ratio of averages for abnormal-genome-signal intensities to control-genome-signal intensities based on averaged signal intensities for both samples.

In a more general case, an aCGH array may contain a number of different features, each feature generally containing a particular type of probe, each probe targeting a particular chromosomal DNA subsequence indexed by index k that represents a genomic location. A subsequence indexed by index k is referred to as “subsequence k.” One can define the signal generated for subsequence k as the sum of the normalized log-ratio signals from the different probes targeting subsequence k divided by the number of probes targeting subsequence k or, in other words, the average log-ratio signal value generated from the probes targeting subsequence k, as follows:

$$C ( k ) = \frac{{\sum }_{b ∈ \{ features containing probes for k \}} C ( b )}{{num\_features}_{k}}$$

where num_featuresₖ is the number of features that target the subsequence k;

C(b) is the normalized log-ratio signal measured for feature b,

$$C ( b ) = {log ( \frac{{J}_{red}}{{J}_{green}} )}_{b} - \frac{{\sum }_{i ∈ \{ allfeatures \}} {log ( \frac{{J}_{red}}{{J}_{green}} )}_{i}}{num\_features} ; and {( \frac{{J}_{red}}{{J}_{green}} )}_{i}$$

is the ratio of measured red signal J_{red} to measured green signal J_{green} for feature i.

### In the case where a single probe targets a particular subsequence, k, no averaging is needed.

To re-emphasize, each aCGH data point is generally a log ratio of signals read from a particular feature of a microarray that contains probes targeting a particular subsequence, the log-ratio of signals representing the ratio of signals emitted from a first label used to label fragments of a genome sample to a signal generated from a second label used to label fragments of a normal, control genome. Both the sample-genome fragments and the normal, control fragments hybridize to normal-tissue-derived probe molecules on the microarray. A normal tissue or sample may be any tissue or sample selected as a control tissue or sample for a particular experiment. The term “normal” does not necessarily imply that the tissue or sample represents a population average, a non-diseased tissue, or any other subjective or object classification. The sample genome may be obtained from a diseased or cancerous tissue, in order to compare the genetic state of the diseased or cancerous tissue to a normal tissue, but may also be a normal tissue.

Subsequence deletions and amplifications generally span a number of contiguous subsequences of interest, such as genes, control regions, or other identified subsequences, along a chromosome. It therefore makes sense to analyze aCGH data in a chromosome-by-chromosome fashion, statistically considering groups of consecutive subsequences along the length of the chromosome in order to more reliably detect amplification and deletion. Specifically, it is assumed that the noise of measurement is independent for each subsequence along the chromosome, and independent for distinct probes. Statistical measures are employed to identify sets of consecutive subsequences for which deletion or amplification is relatively strongly indicated. This tends to ameliorate the effects of spurious, single-probe anomalies in the data. This is an example of an aberration-calling technique, in which gene-copy anomalies appearing to be above the data-noise level are identified.

One can consider the measured, normalized, or otherwise processed signals for subsequences along the chromosome of interest to be a vector V as follows:

V={v₁, v₂, . . . , vₙ}

where vₖ=C(k)
Note that the vector, or set V, is sequentially ordered by position of subsequences along the chromosome. A statistic S is computed for each interval I of subsequences along the chromosome as follows:

$$S ( I ) = ( {\sum }_{k = i , … , j} {v}_{k} ) \cdot \frac{1}{\sqrt{j - i + 1}}$$

where I=v₁, . . . , vⱼ

Under a null model assuming no sequence aberrations, the statistic S has a normal distribution of values with mean=0 and variance=1, independent of the number of probes included in the interval I. The statistical significance of the normalized signals for the subsequences in an interval I can be computed by a standard probability calculation based on the area under the normal distribution curve:

$$Prob ( \vert S ( I ) \vert > z ) \approx ( \frac{1}{\sqrt{2 π}} ) \frac{1}{z} {e}^{- \frac{{z}^{2}}{2}}$$

### Alternatively, the magnitude of S(I) can be used as a basis for determining alteration.

It should be noted that various different interval lengths may be used, iteratively, to compute amplification and deletion probabilities over a particular biopolymer sequence. In other words, a range of interval sizes can be used to refine amplification and deletion indications over the biopolymer.

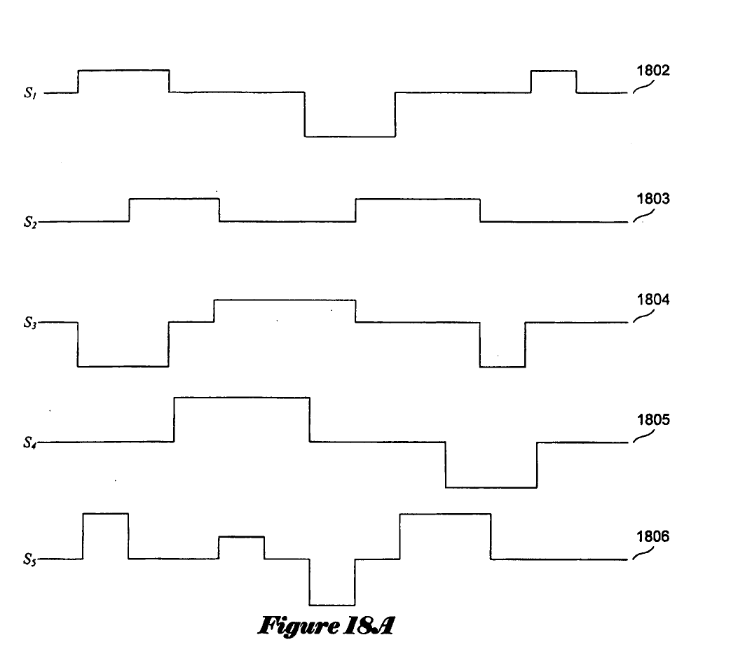

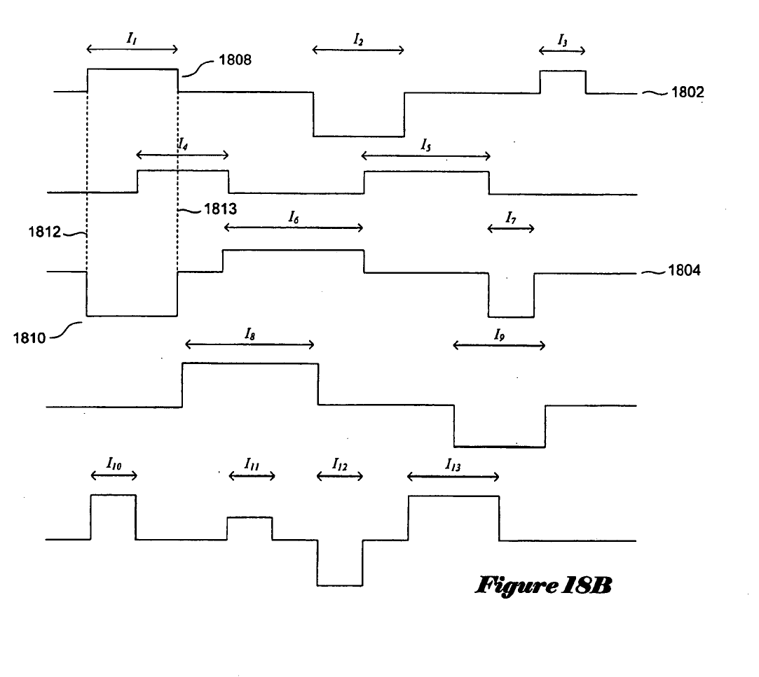

After the probabilities for the observed values for intervals are computed, those intervals with computed probabilities outside of a reasonable range of expected probabilities under the null hypothesis of no amplification or deletion are identified, and redundancies in the list of identified intervals are removed. FIG. 13 illustrates one method for identifying and ranking intervals and removing redundancies from lists of intervals identified as corresponding to probable deletions or amplifications. In FIG. 13, the intervals for which probabilities are computed along the chromosome C₁ (402 in FIG. 4) for diseased tissue with an abnormal chromosome (502 in FIG. 5) are shown. Each interval is labeled by an interval number, Iₓ, where x ranges from 1 to 9. For most intervals, the calculated probability falls within a range of probabilities consonant with the null hypothesis. In other words, neither amplification nor deletion is indicated for most of the intervals. However, for intervals I₆ 1302, I₇, 1304, and I₈, 1306, the computed probabilities fall below the range of probabilities expected for the null hypothesis, indicating potential subsequence deletion in the diseased-tissue sample. These three intervals are placed into an initial list 1308 which is ordered by the significance of the computed probability into an ordered list 1310. Note that interval I₇ 1304 exactly includes those subsequences deleted in the diseased-tissue chromosome (502 in FIG. 5), and therefore reasonably has the highest significance with respect to falling outside the probability range of the null hypothesis. Next, all intervals overlapping an interval occurring higher in the ordered list are removed, as shown in list 1312, where overlapping intervals I₆ and I₈, with less significance, are removed, as indicated by the character X placed into the significance column for the entries corresponding to intervals I₆ and I₈. The end result is a list containing a single interval 1314 that indicates the interval most likely coinciding with the deletion. The final list for real chromosomes, containing thousands of subsequences and analyzed using hundreds of intervals, may generally contain more than a single entry. Additional details regarding computation of interval scores can be found in “Efficient Calculation of Interval Scores for DNA Copy Number Data Analysis,” Lipson et al., Proceedings of RECOMB 2005, LNCS 3500, p. 83, Springer-Verlag.

### Methods for Identifying Common Aberrations

The aberration-calling, or aberration-identifying, methods discussed in the previous subsection can be implemented in a CGH or an aCGH-data-processing system in order to provide automated identification of aberrant intervals within each sample analyzed by a CGH or aCGH technique. These methods also provide a score S(I) that may be associated with each identified aberrant interval. In general, researchers and diagnosticians analyze a large number of samples with the goal of identifying the statistically significant aberrations common to a large number of samples within a multi-sample data set. For example, chromosomal DNA samples obtained from hundreds of patients with a particular type of cancer may be analyzed by an aCGH technique with the hope of identifying a set of chromosomal regions aberrant in a large fraction of, or all of, the chromosomal DNA samples obtained from the hundreds of patients. The common aberrant chromosomal regions may then be correlated with the particular type of cancer. Identifying aberrant chromosomal regions correlated with a particular cancer or other type of pathology may lead to effective diagnostic tools for the particular type of cancer or pathology, methods for analyzing the results of various treatment strategies, and even promising molecular targets for new therapeutic agents. Unfortunately, current CGH and aCGH-data-processing methods and systems do not provide for automated identification of statistically significant, common aberrations from multi-sample data sets. Method and system embodiments of the present invention are directed to automated identification of statistically significant aberrations common to multiple samples of a multi-sample data set.

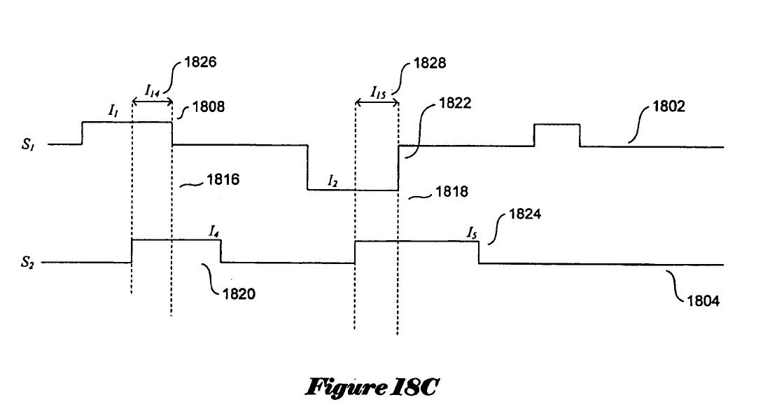

FIG. 14 illustrates the general problem domain to which method and system embodiments of the present invention are directed. In FIG. 14, the illustrated problem domain comprises n chromosomal-DNA samples labeled S₁ to Sₙ and ordered along the vertical axis 1402. Each sample includes multiple copies of m chromosomes, labeled Ch₁ to Chₘ, and shown, in FIG. 14 ordered with respect to the horizontal axis 1404. The aberration-calling method described in the previous subsection, or another aberration-calling method, may be used to identify a set of aberrant intervals within each chromosome of each sample. Methods and system embodiments of the present invention employ any of various aberration-calling methods in order to generate a set of aberrant intervals for each chromosome of each sample. Although aberrant intervals are generally identified on a per-chromosome basis, aberrant intervals are considered, for purposes of describing the present invention, to be associated with an entire sample. In other words, the entire set of chromosomes in each sample may be considered to be one, large genomic DNA sequence, in which aberrant intervals are identified.

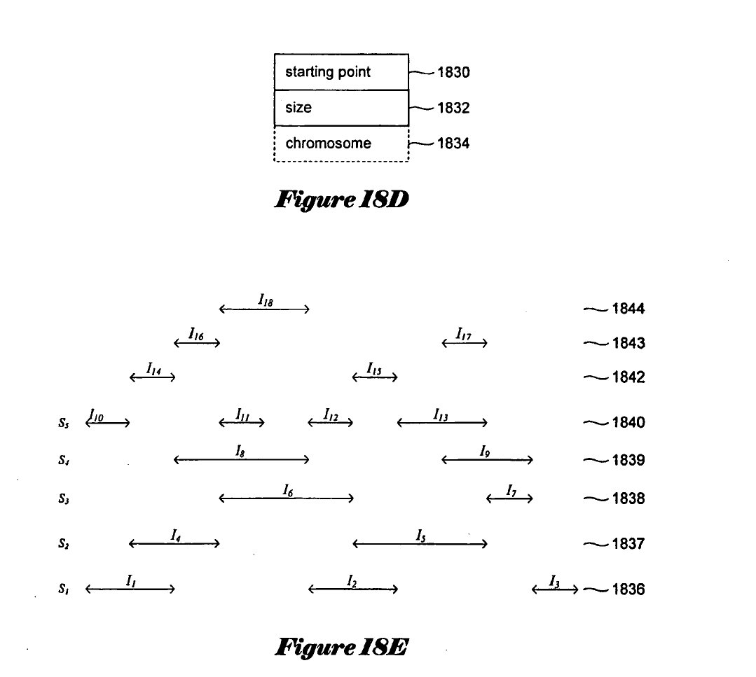

FIGS. 15A-B illustrate an aberrant interval within a chromosome. In FIG. 15A, the determined copy number is shown plotted as a step function 1502 with respect to chromosomal position 1504. The horizontal axis 1504 is incremented in mega-base (“MB”) units. Alternatively, the chromosome can be incremented in probe units, with the positions of probes along the DNA sequence serving as increments. In the current discussion, MB units and probes units are considered to be interchangeable. An aberrant interval 1506 is shown with an increased copy number, relative to a control sample, representing an amplification. The aberrant interval 1506 can be characterized by: (1) a height 1508, representing the relative increase in copy number for the aberrant chromosomal region in a sample with respect to a control; (2) a width 1510 corresponding to the length of the aberrant interval in mega-base units or probe units; and (3) a starting point 1512, designated in MB units or probe units.

FIG. 15B shows a data structure, or record, for representing an aberrant interval detected by an aberration-calling method. The data structure 1516 includes fields with numerical values that identify: (1) the chromosome in which the aberrant interval occurs 1518; (2) the starting point of the aberrant interval in MB or probe units 1520; (3) the size, or length, of the aberrant interval in MB or probe units 1522; (4) the magnitude and direction of the aberration, in copy-number units 1524; (5) a significance value 1526, such as the S(I) score discussed in the previous subsection, associated with the aberrant interval; and (6) a sample identification 1528 that indicates the chromosomal-DNA sample in which the aberration has been detected.

FIGS. 16A-B illustrate a set of aberrant intervals associated with a particular chromosome or genome. As shown in FIG. 16A, a chromosome or genome can be considered to be a length of normal-copy regions, such as normal-copy region 1602, interspersed with amplified regions, or amplified intervals, such as amplified intervals 1604-607, and deleted regions, or deleted intervals, such as deleted intervals 1608-1609. FIG. 16B shows a computational model for the aCGH-analyzed chromosome or genome illustrated in FIG. 16A. As shown in FIG. 16B, each of the aberrant intervals identified within the chromosome or genome can be represented by a data structure, such as the data structure shown in FIG. 15B. These data structures together compose a set of data structures 1612 that can be represented compactly by the notation I_{S,C} 1614. The subscript S represents the sample in which the aberrant interval is identified and the subscript Ch represents the chromosome in which the aberrant interval occurs.

FIG. 17 illustrates, using the illustration conventions previously used in FIG. 14, a data set resulting from CGH or aCGH analysis of each of n samples S₁-Sₙ of a multi-sample CGH or aCGH data set. As shown in FIG. 17, for each chromosome in each sample, a set of aberrant intervals I_{S,Ch} is obtained. Thus, the resulting data set can be thought of as a 2-dimensional matrix of aberrant-interval sets. Method and system embodiments of the present invention are directed to identifying particular intervals within the aberrant-interval sets I_{S,Ch} that are common to a significant number of samples within the sample set S₁-Sₙ.

FIGS. 18A-E illustrate selection of a set of candidate intervals with respect to a multi-sample CGH or aCGH data set, for each sample of which aberrant intervals have been identified. Selection of a candidate interval set is a first step in identifying statistically significant, common intervals for the multi-sample data set. FIG. 18A shows step-function-like representations of hypothetical chromosomes or genomes of a multi-sample set consisting of five samples. The step-function-like representations of the five chromosome or genomes 1802-1806 are vertically aligned with one another in FIG. 18A, to facilitate comparison of aberrant intervals.

FIG. 18B shows a first step in selecting a set of candidate intervals. Each aberrant interval of each sample is considered in turn, starting with the first aberrant interval 1808 identified in the first sample 1802. If the next considered aberrant interval is not already a member of the set of candidate intervals, the next considered aberrant interval is added to the set of candidate intervals. In FIG. 18B, the intervals are labeled I₁-I₁₃, in numerical order of their addition to the candidate interval set. The sixth aberrant interval considered in this process, aberrant interval 1810 identified in sample S₃ 1804, is not added to the set of candidate intervals because this interval exactly coincides with the first interval, I₁ 1808, as indicated in FIG. 18B by dashed lines 1812-1813. The direction and height of the intervals are not considered when comparing the next interval with the intervals already added to the set of candidate intervals. Only the starting points and lengths of aberrant intervals are considered. As a result of this first step, the set of candidate intervals includes a unique, or non-redundant, set of aberrant intervals identified in all of the samples of the multi-sample data set.

In a second step, following addition of the aberrant intervals identified by an aberration-calling method carried out on each individual sample, as discussed with reference to FIG. 18B, intersections of each possible pair of overlapping candidate intervals are identified and added to the set of candidate intervals. As with the aberrant intervals added in the first step, an intersection interval is added to the set of candidate intervals in this second step only if the intersection interval has not already been entered into the set of candidate intervals. FIG. 18C illustrates identification of two interval intersections. In FIG. 18C, the step-function-like representations of the chromosome or genome from samples S₁ 1802 and S₂ 1804 are shown vertically aligned, as in FIGS. 18A-B. The pairs of dashed lines 1816 and 1818 in FIG. 18C show that interval I₁ 1808 in Sample 1 overlaps interval I₄ 1820 in sample S₂. Similarly, interval I₂ 1822 in sample S₁ overlaps intervals I₅ 1824 in sample S₂. The regions of overlap of the two sets of intervals are considered to be intersection intervals I₁₄ 1826 and I₁₅ 1828. Because intervals I₁₄ and I₁₅ have not yet been entered into the set of candidate intervals, the intersection intervals I₁₄ and I₁₅ are entered as the 14^{th} and 15^{th} intervals in the set of candidate intervals for the example shown in FIGS. 18A-E.

FIG. 18D shows a data structure that may be used to represent a candidate interval. The data structure includes fields that numerically represent the starting point of the candidate interval 1830 and the size, or length, of the candidate interval 1832, either in mega bases or in probes. The data structure optionally includes an additional field to indicate the chromosome in which the candidate interval has been identified 1834. This field is optional because candidate intervals can be considered to be specific to particular chromosomes, in which case a chromosome identifier may be needed, or can be considered to be associated with the entire genome, in which case a chromosome-identifying field 1834 is not needed. In other words, the value that describes the starting point may be relative to a particular chromosome or may be relative to a sequential ordering of all chromosomes of the genome into a single sequence. In an alternative embodiment, the data structure may include fields that numerically represent the starting and ending pints for the candidate interval. In the described methods for identifying candidate intervals and in subsequently described computation of per-sample and cumulative significance scores for candidate intervals, only the starting point and size, or the starting and ending points, of each candidate interval are taken into account.

FIG. 18E shows all candidate intervals determined for the hypothetical multi-sample data set shown in FIGS. 18A-B. The first five horizontal rows 1836-1840 of candidate intervals in FIG. 18E include aberrant intervals originally identified by a per-sample application of an aberration-calling technique, and the remaining three horizontal rows 1842-1844 of candidate intervals represent intersection intervals between pairs of the originally identified aberrant intervals shown in horizontal lines 1836-1840. By considering all possible intersection intervals generated from pair-wise consideration of the originally identified intervals, all possible m-way intersection intervals are obtained, where m ranges from 2 to n, the number of samples.

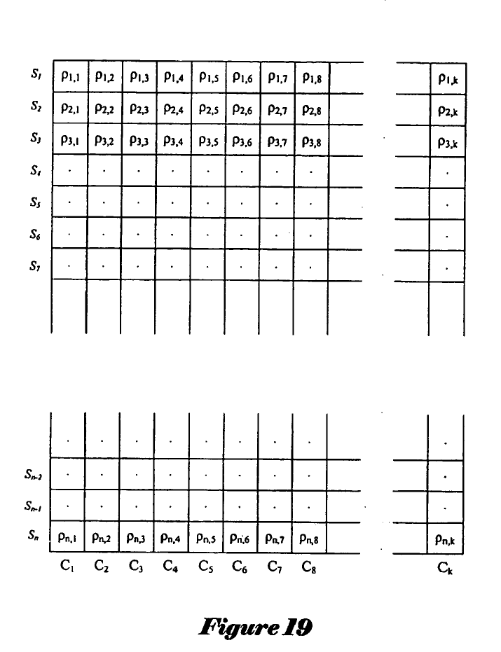

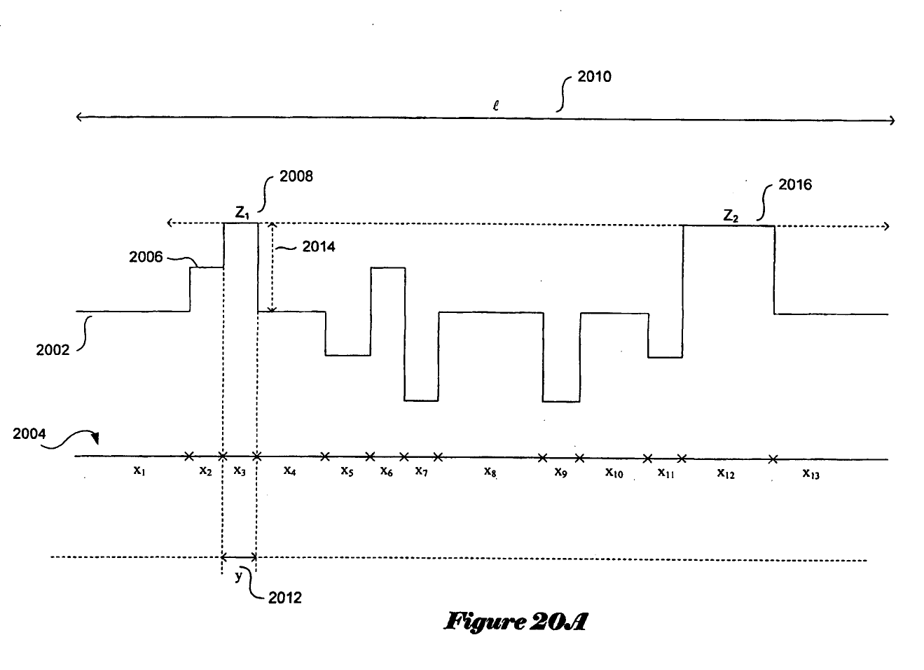

In a next step employed in method and system embodiments of the present invention for identifying statistically significant, common aberrations in a multi-sample CGH or aCGH data set, a first, initial statistical score is assigned to each candidate interval for each sample in the multi-sample data set for amplification, and a second, initial score is assigned to each candidate interval for each sample in the multi-sample data set for deletion. In other words, each candidate interval is evaluated with respect to each sample to produce a statistical score for each candidate-interval/sample pair with respect to amplification and with respect to deletion. FIG. 19 shows an illustration of the per-sample statistical scores generated for each candidate-interval/sample pair for one of amplification or deletion. As shown in FIG. 19, results of this first scoring step can be considered to be a 2-dimensional array of statistical scores, such as the statistical score ρ_{1,1} 1902 representing the statistical score generated for the candidate interval c₁ when the candidate interval c₁ is evaluated with respect to sample S₁ for one of amplification or deletion. A number of different statistical scores can be computed by a number of different methods in various alternative embodiments of the present invention. In one embodiment, the above-discussed score S(I) produced by the above-described aberration-calling mechanism may be used as the statistical score for each candidate interval. In this case, the candidate interval is statistically scored, with respect to the chromosome in which the candidate interval was initially detected, in each of the sample data sets.

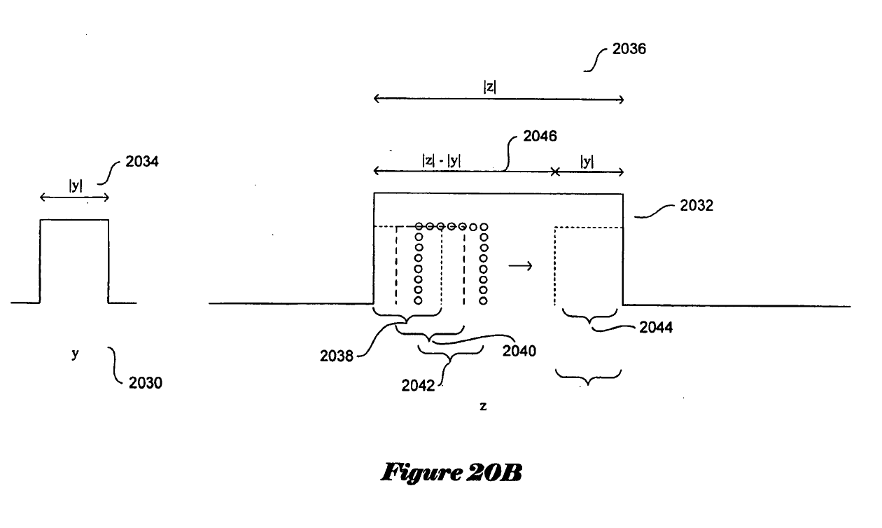

In alternative embodiments, a chromosome-context-based method or a genome-context-based method can be used to determine a statistical score for each candidate interval with respect to each sample and with respect to amplification or deletion. FIGS. 20A-B illustrate computation of a context-based statistical score. The computation of the context-based statistical score is essentially the same in both the chromosome-context and genome-context embodiments. A step-function-like representation of aberrations identified in the chromosome from which the candidate interval was originally identified, in the chromosome-context-based method, or a step-function-like representation of the entire genome, in the genome-context-based method, is first prepared. FIG. 20A shows a step-function-like representation of either a chromosome context or genome context 2002. Each step of the step function is separately considered. For example, in the step-function-like representation of the context 2002 shown in FIG. 20A, 13 steps, or step intervals, are identified, as shown in the horizontal line of step intervals 2004. Certain of these step intervals may exactly coincide with aberrant intervals identified by aberration-calling method. However, in the case of nested aberrant intervals, certain of these steps, or step intervals, may represent superpositions of two different nested aberrant intervals. For example, the two step intervals x₁ 2006 and x₂ 2008 in the step-function-like representation may result from a first aberrant interval and a second aberrant interval identified by the aberration-calling method. However, these two step intervals may also correspond to a narrow four-fold amplification, coinciding with step 2008, nested within, or superimposed on, a longer, two-fold amplification that spans steps 2006 and 2008. In the described method, it is immaterial whether steps represent nested aberrant intervals or discrete, separated aberrant intervals.

The context, either a chromosome or the entire genome, has a context length 2010 represented by the symbol “1.” A candidate interval 2012 is represented by the symbol “y.” The context-based statistical score is essentially proportional to the probability that the region of the context corresponding to the candidate interval y is either amplified, in the case of the amplification related initial statistical score, or deleted, in the case of the deletion-related statistical score, in the chromosomal or genomic context for a particular sample. In a first step of the context-based method, the magnitude 2014 of either the amplification or deletion of the region of the context corresponding to the candidate interval y is determined. For computing a context for context-based determination of a per-sample statistical score with respect to amplification, the minimum height of any step interval that occurs in a region of the sample corresponding to the candidate interval is selected as the candidate interval height with respect to the sample. For computing a context for context-based determination of a per-sample statistical score with respect to deletion, the maximum height of any step interval that occurs in a region of the sample corresponding to the candidate interval is selected as the candidate interval height with respect to the sample. Then, the remaining step intervals are compared to candidate interval height 2014. In the case of computing an amplification-related statistical score, only those step intervals with heights equal to, or greater than, the candidate interval height 2014 and with widths equal to, or greater than, the candidate interval width are considered along with the step interval corresponding to the candidate interval y. In the current example, only the step interval corresponding to the candidate interval y 2008 and the final step interval in the context, step interval 2016, are therefore considered. These two intervals together comprise the set of qualified intervals {z₁, z₂}, in which the context-based statistical score is computed. A similar process is used to generate qualified intervals when the candidate interval y is considered for deletion. In the deletion case, only those step intervals with heights equal to, or lower in height than, the candidate interval height and with widths equal to, or greater than, the candidate interval width are considered as qualified intervals.

Next, as shown in FIG. 20B, the candidate interval y 2030 is compared to each qualified interval, such as qualified interval z 2032 shown in FIG. 20B. The candidate interval y has length |y| 2034 and the qualified interval to which it is being compared has length |z| 2036. Consider placing the candidate interval y within the qualified interval z such that the candidate interval y is contained completely within the qualified interval z. The qualified interval could be placed at a first position 2038 in which the left-hand edge of the candidate interval y coincides with the left-hand edge of the qualified interval z. The candidate interval could be moved rightward, through a continuous set of intermediate positions, such as intermediate positions 2040 and 2042, up to a final position 2044 in which the right-hand edge of the candidate interval y coincides with the right-hand edge of the qualified interval z. In other words, the starting position of the candidate interval y could fall anywhere within a length of |z|−|y| 2046 and allow the candidate interval y to be fully contained within the qualified interval z. Similarly, the starting point for the candidate interval y could be placed anywhere along a line segment of length it |1|−|y| in order to be fully contained within a context of length |1|. The probability that the candidate interval y may occur within an interval of a length equal to a qualified interval z, P(y⊂z), is thus:

$$P ( y ⊆ z ) = \frac{\vert z \vert - \vert y \vert + ɛ}{\vert l \vert - \vert y \vert + ɛ}$$

where ε is a constant of small magnitude that prevents numerical instability in certain boundary cases. The probability that the candidate interval y is aberrant within a sample Sᵢ, P(y is an abberation in Sᵢ), is then:

$$P ( y is an abberation in {S}_{i} ) ≡ {\sum }_{k = 1}^{q} P ( y ⊆ {z}_{k} )$$

where k ranges from 1 to the number of qualified intervals q. The computed probability P(y is an abberation in Sᵢ) is used as the context-based statistical score assigned to candidate interval y for a sample Sᵢ in one embodiment of the present invention. The statistical score represents a probability that the candidate interval is aberrant within a particular sample. The statistical scores range from 0, indicating no probability of the interval being aberrant, to 1, indicating a 100 percent probability that the candidate interval is aberrant.

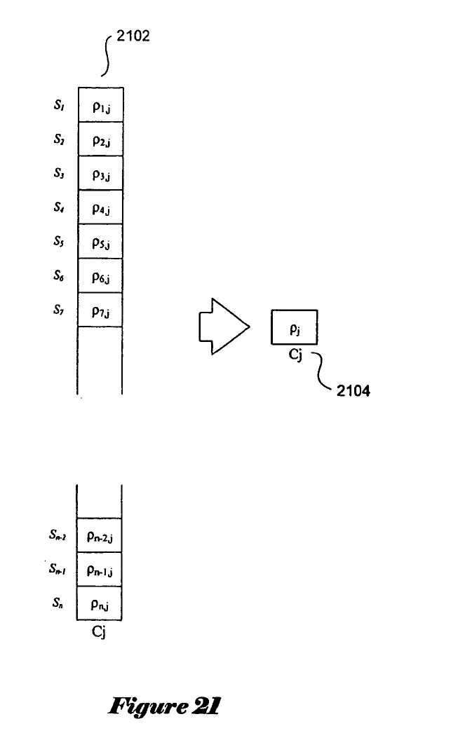

By whatever method a per-sample statistical score is assigned to each candidate interval with respect to each sample and with respect to one of amplification and deletion, the above-described step of the process employed in method and system embodiments of the present invention for identifying statistically significant, common aberrations in a multi-sample data set results in two, 2-dimensional arrays of statistical scores such as the 2-dimensional array of statistical scores shown in FIG. 19. In a next step of the process, the per-sample statistical scores for each candidate interval are used to compute a cumulative significance score for each candidate interval for each of amplification and deletion. FIG. 21 illustrates computation of a cumulative significance score for each candidate interval. As shown in FIG. 21, the per-sample statistical scores for a particular candidate interval cⱼ for one of amplification or deletion represents a single column 2102 of a 2-dimensional matrix as shown in FIG. 19. Computation of a cumulative significance score for a candidate interval involves computing, from the column of per-sample statistical scores 2102 associated with the candidate interval cⱼ, a single scalar value 2104 representing the cumulative significance score for the candidate interval cⱼ.

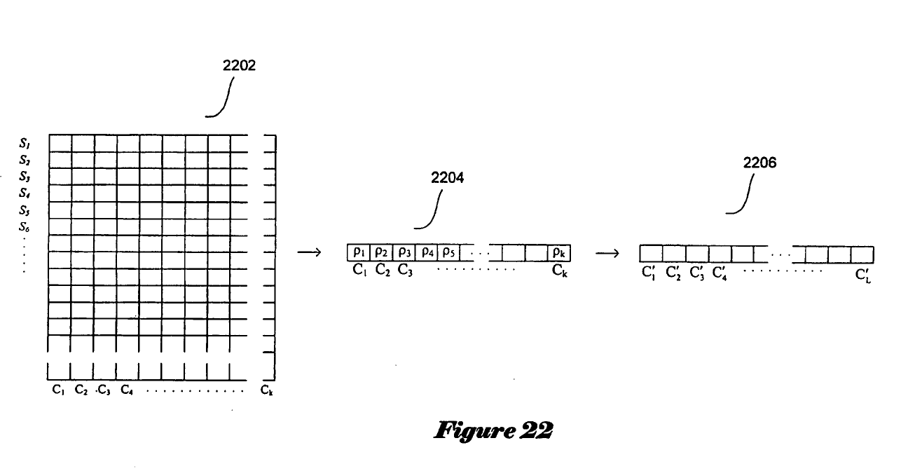

FIG. 22 illustrates remaining steps, following preparation of the 2-dimensional arrays of per-sample statistical scores discussed with reference to FIG. 19, of a process for identifying statistically significant candidate intervals that represents on embodiment of the present invention. As shown in FIG. 22, a 2-dimensional array of per-sample statistical scores 2202, each column of which represents a set of per-sample statistical scores computed for a given candidate interval, is collapsed, by the method described above with reference to FIG. 21, into a row vector 2204 containing cumulative significance scores for each candidate interval cⱼ. In a final step, the row vector may be sorted to produce a sorted row vector 2206 in which the cumulative significance scores occur in increasing numerical value, or decreasing significance. In other words, in the sorted row vector, the candidate intervals that index the row vector occur in descending order with respect to statistical significance. Therefore, a threshold statistical value may be used to select the most significant candidate intervals that together comprise a right-hand prefix of the row vector, which may then be returned as the set of statistically significant candidate intervals. In certain embodiments of the process, the method by which per-sample statistical scores are collapsed into cumulative significance scores result in a sorted row vector, without need for a discrete sorting step.

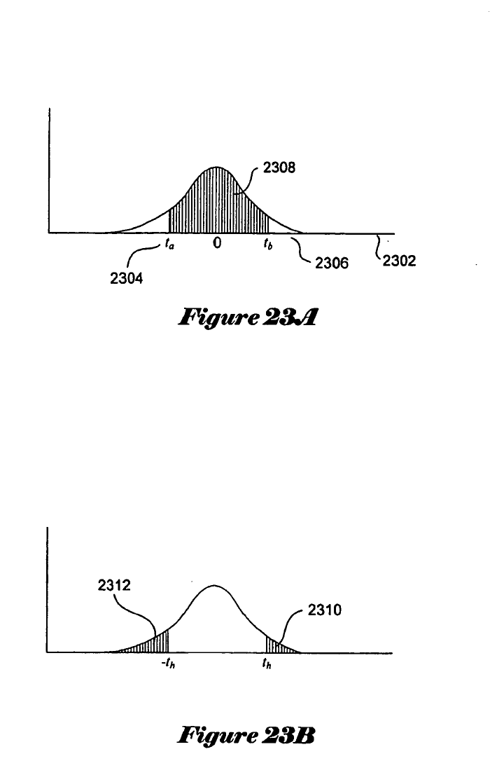

In certain embodiments of the present invention, a cumulative significance score for each candidate interval with respect to each of amplification and deletion is computed from the per-sample statistical scores for the candidate interval based on t-test statistics. FIGS. 23A-B shows a t-test probability distribution ƒ(t). The t-test probability density function ƒ(t) is plotted in FIG. 23A with respect to the variable t, a continuous domain of values of which are represented by horizontal axis 2302. The area under the t-test probability-density-function curve is equal to 1.0 or, in other words, the t-test distribution is normalized. The probability that the value of the variable t falls within a range [tₐ,t_{b}] is equal to the area under the t-test curve between the t values tₐ 2304 and t_{b} 2306. The area is shaded 2308. Thus, the probability that t lies between tₐ and t_{b} is given by:

$$P ( {t}_{a} \leq t \leq {t}_{b} ) = {\int }_{t = {t}_{a}}^{{t}_{b}} f ( t ) d t$$

In one embodiment of the present invention, the total statistical score for a candidate interval is estimated as the average of the per-sample statistical scores, ρᵢ, computed according to the methods described above or according to other per-sample-statistical-score-computing methods:

$$\overline{y} = \frac{1}{n} {\sum }_{i = 1}^{n} {ρ}_{i}$$

and the variance for the per-sample statistical scores ρᵢ is estimated as:

$${S}^{2} = \frac{1}{n - 1} {\sum }_{i = 1}^{n} {( {ρ}_{i} - \overline{y} )}^{2}$$

In one embodiment of the present invention, the S(I) scores returned by an aberration-calling method are used for the per-sample statistical scores ρᵢ. A quantity T may be defined as:

$$T = \sqrt{n} ( \frac{\overline{y}}{S} )$$

where y̅ is the estimated average of the per-sample statistical scores,

n is the number of observations, and

S is the observed variance.

### T is distributed according to the t-test distribution, which allows for assigning a probability that the estimated average differs from 0 by bounds related to the variance.

A p-value for a particular hypothesis, such as the hypothesis that an interval is not aberrant, can be derived from a t-test distribution. A t-test distribution with n−1 degrees of freedom can be computed for a t-test-distributed quantity and can be used to estimate the probability of observing a particular value for the t-test-distributed quantity, such as the T statistic discussed above, in a test with n samples. FIG. 23B shows areas 2310 and 2312 under the tails of a t-test probability density function distribution. When the left-hand boundary of the right-hand tail is set to the value tₕ, the area of the right-hand tail represents the probability of observing a computed value greater than tₕ. The p-value of a statistical hypothesis test is the probability of observing a value of a test statistic as extreme as or more extreme than an observed value of the test statistic. When the computed probability, or p-value, is less than a threshold p-value, the null hypothesis is rejected. For example, when the p-value computed for a T statistic is less than a threshold value, such as 0.05, then the hypothesis that the interval is not amplified may be rejected. Thus, the area under the right-hand tail bounded by th corresponds to the p-value for an observed test statistic with value tₕ. Two-sided tests can be used when the computed test statistic can be either positive or negative, such as when the computed test statistic is related to the magnitude of a value. Two-sided tests are based on the areas under both tails, bounded by values tₕ and −tₕ. One-sample t-tests can be used for estimating p-values for a test statistic computed from one set of samples. A two-sample t-test can be used to compute a p-value for a test statistic computed from two different sets of samples, useful for testing a hypothesis such as the hypothesis that the two different sets of samples both have a common mean test-statistic value and are equivalently distributed. In one embodiment of the present invention, the cumulative significance score for a candidate interval is computed as a combination of the average of the per-sample statistical scores and a p-value obtained by one-sample t-test statistics assuming the candidate interval to be present at a normal copy number. For computing the cumulative significance score with respect to amplification, a one-sided t-test based on the right-hand tail is employed. For computing the cumulative significance score with respect to deletion, a one-sided t-test based on the left-hand tail is employed.

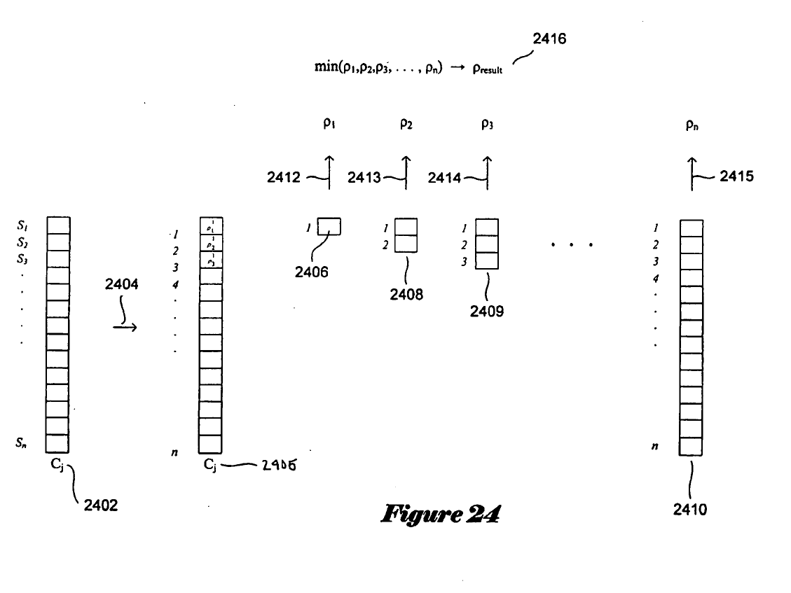

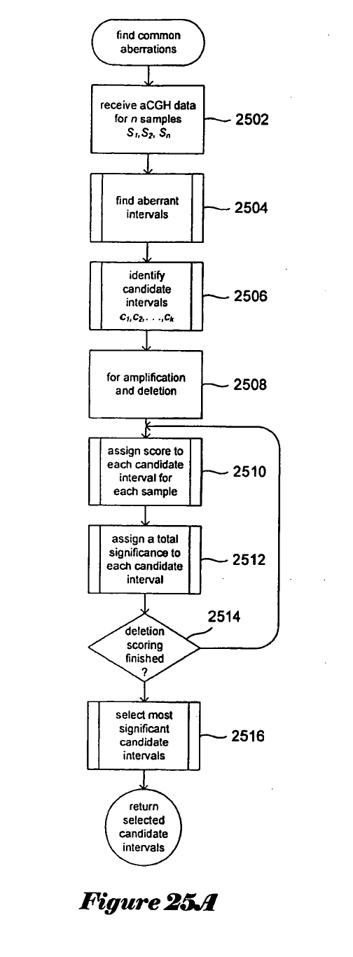

FIG. 24 illustrates an alternative method for computing a cumulative significance score for a candidate interval. The alternative method starts with a column vector 2402 containing per-sample statistical scores for a particular candidate cⱼ. First, the statistical scores are sorted 2404 to produce a modified column vector in which the statistical scores ascend in numerical order with increasing indexes, or, in other words, are ordered most surprising to least surprising. Next, prefix vectors of the modified column vector are generated, beginning with a first prefix vector including only the first element of the modified column vector 2406 and proceeding through prefixes of monotonically increasing length 2408-2409 to a final, longest prefix vector equal to the original, modified column vector 2410. A statistical score is computed for each prefix, indicated in FIG. 24 by the vertical arrows 2412-2415 pointing to computed statistical scores P₁, P₂, . . . Pₙ. In one embodiment of the present invention, the minimum numerically valued statistical score, or the statistical score indicating the least probability, is chosen as the resulting cumulative significance score 2416 for the candidate interval cⱼ. In alternative embodiments of the present invention, another minimally or maximally valued score or metric, such as the minimal false discovery rate, may be selected as the resulting cumulative significance score.

A number of different scores may be computed, by various methods, and assigned to prefix vectors for use in computing a cumulative significance score as described with reference to FIG. 24. In one method, a prefix score can be computed as the estimated average of the scores in the prefix combined with a p-value generated from t-test statistics. In an alternative method, a Chernoff bound is employed to compute a p-value-like score. A Chernoff bound may be is described as follows:

$$Let {X}_{1} , … , {X}_{n} be independent random$$

$$variables such that P ( {X}_{i} ) = {p}_{i} . \\ Let Z = {\sum }_{i = 1}^{n} {X}_{i} and let μ = E [ Z ] . \\ Then P ( Z \geq ( 1 + δ ) μ ) < {( \frac{{e}^{δ}}{{( 1 + δ )}^{( 1 + δ )}} )}^{μ}$$

The Chernoff bound is applied to a prefix vector of length k containing k statistical scores ρ₁, ρ₂, . . . , ρₖ, where ρ₁≦ρ₂≦. . . ≦ρₖ, as follows:

$$\hat{p} = {ρ}_{k}$$

$$μ = ( \hat{p} ) ( n )$$

$$δ = \frac{k - μ}{μ}$$

$$if δ equals 0 , then {P}_{k} = 0$$

$$else {log}_{10} {P}_{k} = μ ( \frac{δ}{ln ( 10 )} - ( 1 + δ ) {log}_{10} ( 1 + δ ) )$$

### The values log₁₀ Pₖ or the value Pₖ computed above for a prefix can be used as the statistical score for the k^{th} prefix in the method discussed with reference to FIG. 24.

Similar methods can be employed to determine whether or not a candidate interval shows a significance difference in copy number in one group of samples with respect to another group of samples. In one embodiment of the present invention, a difference in copy number for a candidate interval c in a first group of samples S₁={u₁, u₂, . . . , uₙ} and a second group of samples S₂={v₁, v₂, . . . , vₘ} is determined by: (1) computing S(I) values for the candidate interval with respect to each sample in S₁ and S₂, computing a t-test-distributed test statistic related to the S(I) values for candidate interval c with respect to each of the two groups of samples S₁ and S₂, and then using a two-sample t test to decide whether the S(I) scores for the two groups of samples S₁ and S₂ are similarly distributed as well as the p-value associated with the determination. All candidate intervals for the two groups of samples S₁ and S₂ can be evaluated by the two-sample t test method and each candidate interval can be assigned a score reflective of the probability that the copy number of the candidate interval differs in the two groups of samples. The candidate intervals can then be sorted according to the assigned scores, to reveal the candidate intervals most likely to be present in different copy numbers in the two groups of samples.

The method of evaluating candidate intervals for similar distribution in two groups of samples can be extended to analysis of k groups of samples, where k is greater than 2. For example, candidate intervals that are dissimilarly distributed in the k different samples may be found by pairwise application of two-sample t-test-based statistical methods or by ANOVA statistical methods based on the F-distribution. The degree of dissimilarity may be numerically expressed in different ways depending on the statistical analysis method used, and used to order candidate intervals by their ability to distinguish groups of samples by comparing aberration-calling results for the candidate intervals in the k groups of samples.

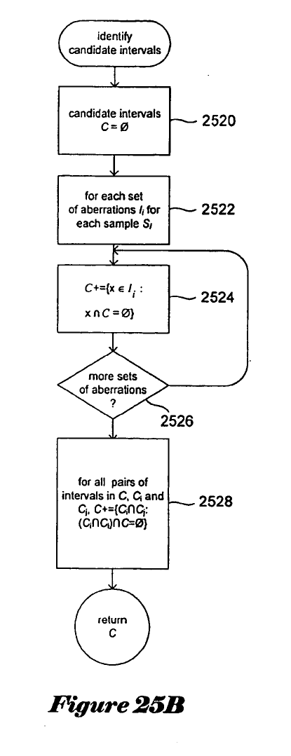

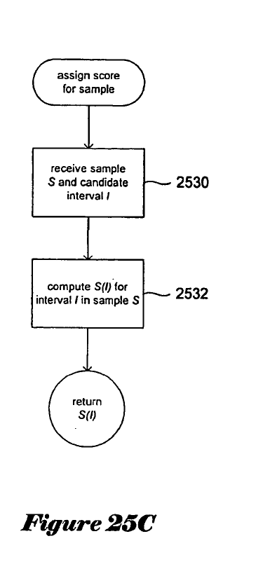

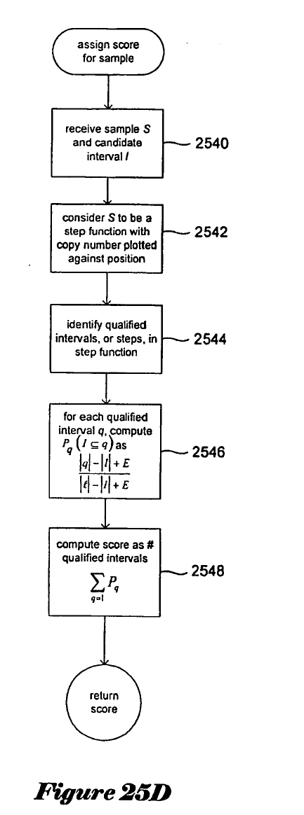

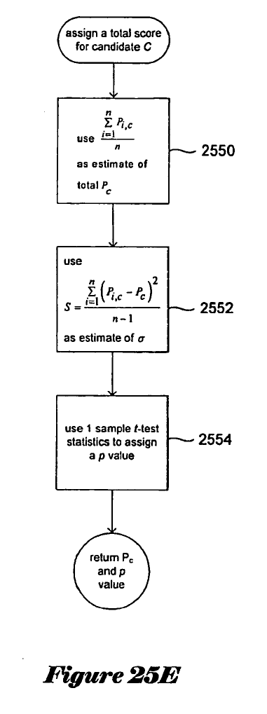

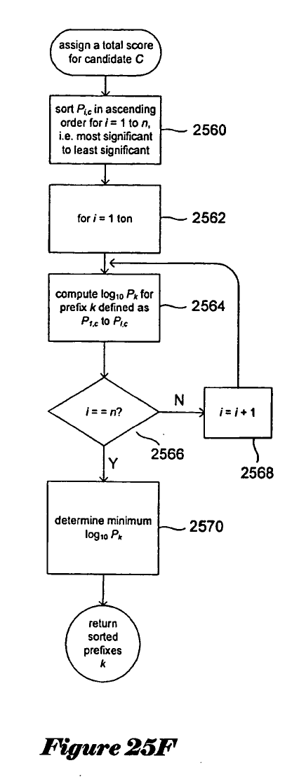

FIGS. 25A-F show control-flow diagrams that illustrate a number of steps in various embodiments of the present invention. FIG. 25A shows a control-flow diagram illustrating a routine “findCommonAberrations” that represents an overall approach, or computational framework, for many embodiments of the present invention. In a first step 2502, the routine “finidCommonAberrations” receives a CGH or aCGH data set comprising CGH or aCGH data for n samples S₁, S₂, . . . , Sₙ. Next, in step 2504, the routine “findCommonAberrations” invokes any of numerous different aberration-calling methods, such as the aberration-calling method discussed in the previous subsection, to identify aberrant intervals in the chromosomes of each of the different n samples. Next, in step 2506, the routine “findCommonAberrations” identifies a set of candidate intervals c₁, c₂, . . . , cₖ using the method discussed above with reference to FIGS. 18A-E. In the for-loop including steps 2508, 2510, 2512, and 2514, steps 2510 and 2512 are executed twice, once for assigning a cumulative significance score to each candidate interval with respect to amplification and once for assigning a cumulative significance score to each candidate interval with respect to deletion. In step 2510, a per-sample score is assigned to each candidate interval for each sample to generate a 2-dimensional array of per-sample scores, such as the 2-dimensional array of per-sample scores shown in FIG. 19. Then, in step 2512, per-sample statistical scores generated for each candidate interval are used to compute a cumulative significance score for each candidate interval, as described above with reference to FIG. 21. Finally, in step 2516, the most significant candidate intervals are selected based on the cumulative significance scores assigned to each candidate interval, and the most significant candidate intervals are returned. In many embodiments of the present invention, the returned significant candidate intervals are each accompanied with indications of the sample subsets in which the interval is aberrant.

FIG. 25B shows a control-flow diagram for one approach to identifying a set of candidate intervals C for a multi-sample aCGH data set. In step 2520, the set of candidate intervals C is set to null. Next, in the for-loop of steps 2522, 2524, and 2526, each aberrant interval from the set of aberrant intervals identified by the aberration-calling mechanism invoked in step 2504 is considered. If the next considered aberrant interval is not already included in the set of candidate intervals C, then the next considered aberrant interval is included in C in step 2524. Then, in step 2528, all possible intersection intervals generated from pair-wise overlaps of the intervals in C at the completion of the for-loop of steps 2522, 2524, and 2526 are considered, and any such intersection intervals that have not already been added to C are then added to C in order to complete the set of candidate intervals. Efficient techniques that compute all possible intersections from pairs of overlapping intervals in less than O(n²) time may be employed in step 2528.

FIG. 25C shows a control-flow diagram of one method for assigning a per-sample statistical score to a candidate interval. In step 2530, sample data S and a candidate interval I is received. In step 2532, the statistic S(I) for the received interval I with respect to sample data S is computed as in the aberration-calling program described in the previous subsection.

FIG. 25D illustrates an alternative method for computing a per-sample physical score for a candidate interval. In step 2540, sample data S and the candidate interval I are received. Next, in step 2542, the sample data S is considered as a step-function-like context, as discussed above with reference to FIG. 20A. In step 2544, qualified intervals, or interval steps, are determined by the method discussed above with reference to 20A. Then, in step 2546, a probability is computed for the candidate interval I with respect to each qualified interval and, in step 2548, the computed probabilities are summed together to produce a final statistical score for the candidate interval I with respect to sample S. As discussed above with reference to FIGS. 20A-B, the context may either be a single chromosome or may be the entire genome.

FIG. 25E is a control-flow diagram for a routine that assigns a cumulative significance score to a candidate interval c. In step 2550, an average of the per-sample statistical scores for the candidate interval c is computed. Next, in step 2552, the variance for the per-sample scores is computed. Finally, in step 2554, one-sample t-test statistics are used to assign a p-value to the computed average in order to provide a final, cumulative score for the candidate interval c that reflects both the average of the per-sample scores as well as sample variance of the per-sample statistical scores. The cumulative score may also be computed as any of various mathematical combinations of the average and p-value.

FIG. 25F is a control-flow diagram for an alternate method for computing a cumulative significance score for a candidate interval c. In step 2560, per-sample statistical scores associated with the candidate interval C are sorted in ascending numerical order to produce a column vector, as described with reference to FIG. 24, above. Next, in the for-loop of steps 2562, 2564, 2566, and 2568, a score is computed for each of the prefix vectors, as also discussed above with reference to FIG. 24. Finally, in step 2570, the minimum of the computed scores for the prefixes is determined, and that minimum score is returned as the cumulative significance score for the candidate interval c.

Although the present invention has been described in terms of particular embodiments, it is not intended that the invention be limited to this embodiment. Modifications within the spirit of the invention will be apparent to those skilled in the art. For example, any of the various embodiments of the present invention discussed above may be included in software for analysis of aCGH data as well as in automated instruments and/or system that generate and analyze CGH and aCGH data. The various method embodiments of the present invention may be implemented in any number of different programming languages, using different modular structures, control structures, data structures, variables, and wide variations in other programming parameters. As discussed above, any of many different aberration-calling methods can be used for initially identifying aberrant intervals in a multi-sample CGH or aCGH data set. As also discussed above, any of a large variety of different methods can be used to produce a variety of different types of per-sample statistical scores and cumulative scores for candidate intervals in order to identify the most significant candidate scores. Although the described embodiments are directed to analysis of CGH and aCGH data, the present invention can be more generally applied to identifying subsequences with common properties within multiple sequences.

### Methods for Visualizing Common Aberrations

In addition to the above-described aberration calling methods and common aberration identifying methods, a computer-implemented method for viewing comparative genomic hybridization (CGH) data is provided. In certain embodiments, the method may include: a) inputting a plurality of CGH data sets for a corresponding plurality of genomic samples into a computer memory; b) analyzing the CGH data sets using an aberration calling method to identify chromosomal regions having aberrant copy number; and c) producing a graphical user interface that shows graphical representations of a chromosome from each of said genomic samples. The graphical representations show the chromosomal regions having aberrant copy number, and may be aligned adjacent to each other so that for each chromosome displayed, regions having aberrant copy number can be observed. The method may further include executing instructions to identify chromosomal regions having aberrant copy number that are common in selected chromosomes, and indicating the common aberrant regions on the graphical representations.

The method provides a graphical user interface in which copy number aberrations that are common across a plurality of selected genomic samples may be visualized and evaluated by eye. Copy number aberrations that are deemed by a user to be insignificant may be filtered out and ignored. In certain embodiments, groups of samples may by selected, separately analyzed by an aberration calling method, and viewed to identify aberrations that are common in each of the groups of samples, but different between the groups of samples. In other embodiments, samples may be independently analyzed using different aberration calling methods may, and viewed. Aberration calling methods and common aberration identifying methods are described above and in, e.g., U.S. patent application Ser. Nos. 11/338,515, 10/953,958 and 11/363,699, which patent application are incorporated by reference herein for that purpose.

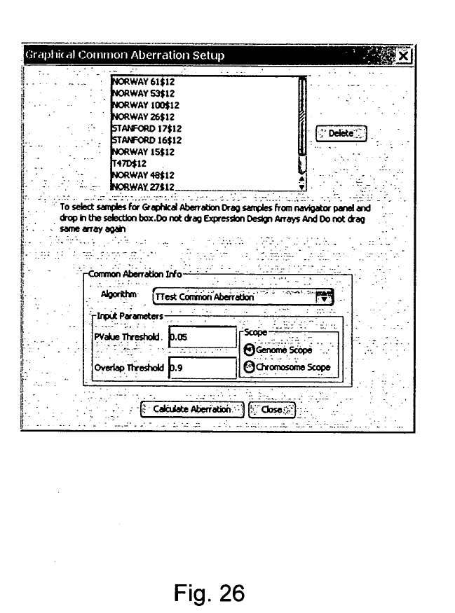

In one embodiment illustrated in FIG. 26, data sets may be selected for analysis by a user using a user interface of a computer by any convenient method, e.g., by “drag and drop” methods or by checking a box associated with the file. In certain embodiments (and as shown in FIG. 26), the user interface may allow a user to select a particular aberration calling method, and execute (e.g., by means of a clickable button) the selected aberration calling method. In certain embodiments, a user may also change input parameters, such as the threshold probability value used to call an aberration, and overlap parameters, using the user interface prior to executing the method.

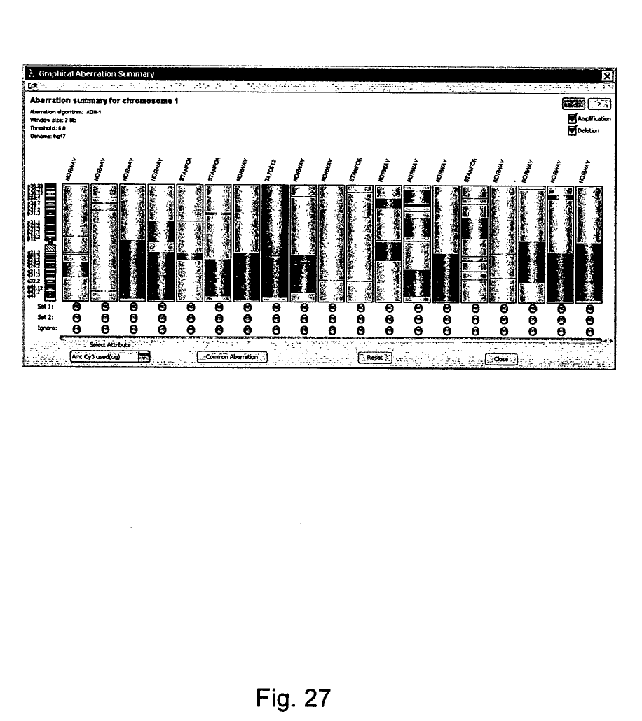

After selection of the data sets to be analyzed, an aberration calling method, e.g., an aberration method described above, may be executed to identify chromosomal regions that have an aberrant copy number. As illustrated in FIG. 27, execution of the method produces a graphical user interface that shows graphical representations of an entire chromosome (in this case, chromosome 1), or a portion thereof, from each of the genomic samples. The graphical representations show chromosomal regions that are called as having aberrant copy number. As illustrated in FIG. 27, the graphical representations (termed “aberration summaries”) may of the same scale and aligned next to each other, and the chromosomal regions having aberrant copy number may be color coded according to their type. For example, regions having aberrantly high copy number (e.g., amplified regions) may be colored in one color, and regions having aberrantly low copy number (e.g., regions that contain a deletion) may be colored in another color. In certain embodiments and as shown in FIG. 27, the graphical representations may be aligned next to a map of the chromosome to which they correspond. Another chromosome may be viewed in the graphical user interface by selecting that chromosome by any suitable method, e.g., by typing the number of that chromosome into a field, or by clicking on a field in a table.

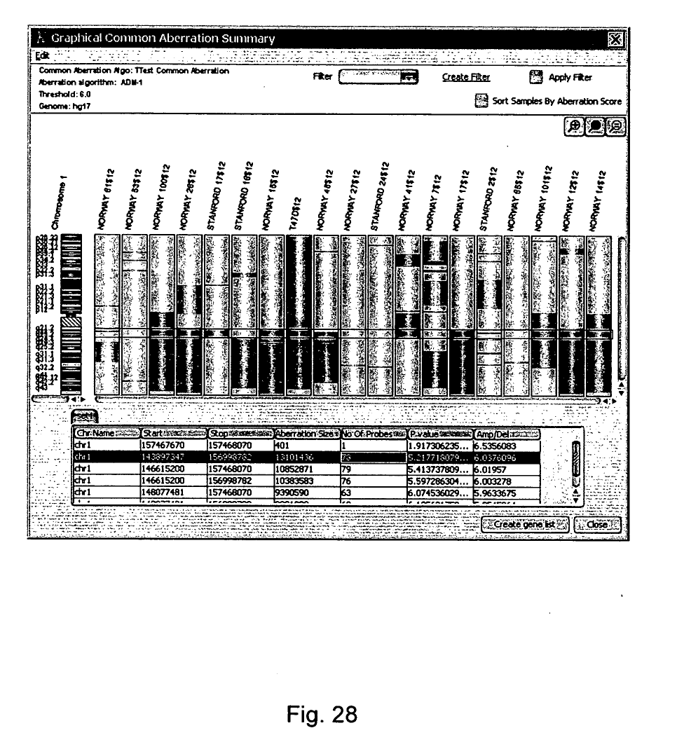

A subset or all of the graphical representations may be selected (e.g., by checking a field associated with the graphical representations), and aberrant regions that are common in the selected chromosome (i.e., the “common aberrant regions” of that chromosome) may be viewed by executing a method to identify those regions. Exemplary methods for identifying common aberrant regions are set forth above. In certain embodiments, once executed, the method may produce a list of common aberrant regions that may be viewed in the graphical user interface (as shown at the bottom of FIG. 28). Individual common aberrant regions may be selected from the list, and the selected common aberrant region may be indicated on the graphical representations containing that region, e.g., as a line or box around that region. As would be readily apparent, the instant programming may provides for zoom in and zoom out functions so that allow a user to view a selected region of a chromosome in greater detail, or less detail, as desired.

Annotation information for a common aberrant region identified using these methods (e.g., a list of names for gene that are in the common aberrant region) may be obtained by executing an annotation-retrieval method, e.g., by depressing a button that executes that method (see, e.g., the “Create gene list” button on FIG. 28). In certain embodiments, the annotation information may open as a separate window to the graphical user interface discussed above.

Upon visual inspection of a common aberrant region, a user may filter that region out of future analysis if, for example, the user decides that the common aberrant region looks insignificant. Further, data for individual probes may be also filtered out. If a common aberrant region is filtered out using the table, that common aberrant region may be removed from the graphical representations (e.g., a region that was once colored becomes the color of the remainder of the chromosome). The data may be re-analyzed after certain data points have been filtered out.

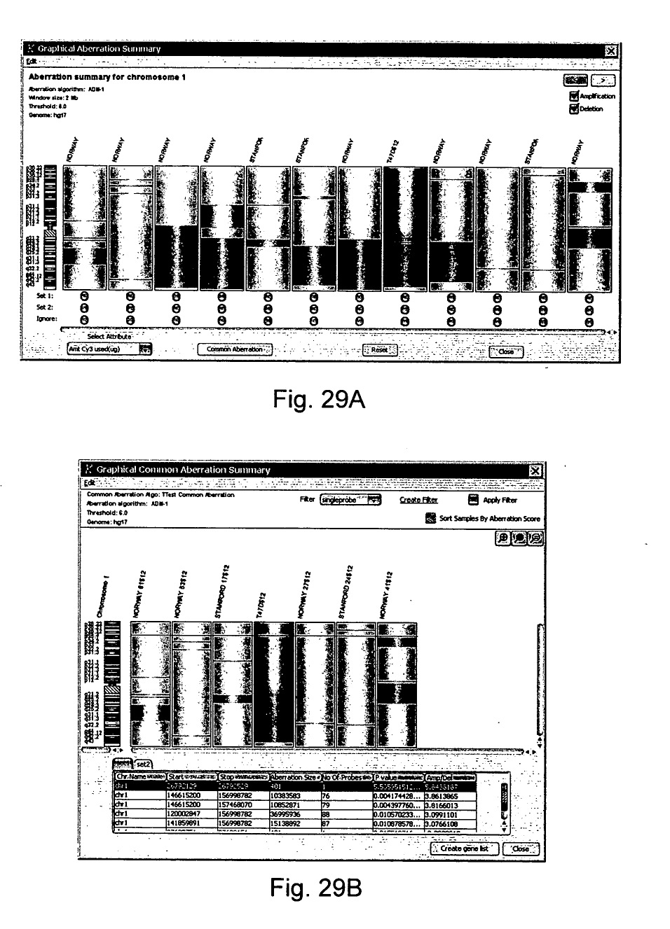

In certain embodiments and as shown in FIGS. 29A and 29B, the instant visualization method further provide for selection of more than one subset of samples for analysis, thus allowing a user to view differences in common aberration patterns between two or more subsets of the samples.

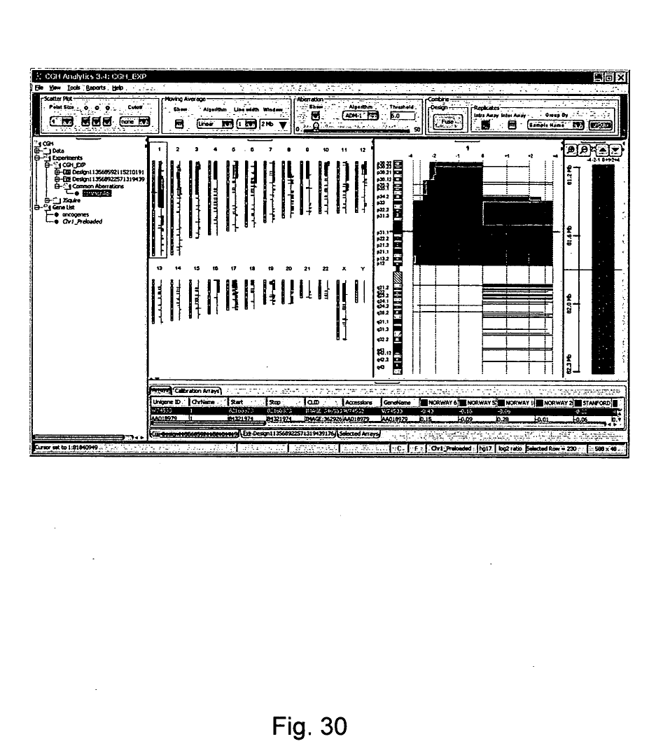

In another embodiment, common aberrations may be displayed on the graphical user interface a tree, where common aberrations are node on the tree. In particular embodiments, the methods may arrange the order of the graphical representations, for each chromosome, according to similarities in their aberrant. In these embodiments (and as shown in FIG. 30), the graphical representations that are most similar pattern of aberrant regions may be adjacent to one another, whereas the graphical representations that are the most difficult are furthest apart. In this embodiment, the graphical user interface may provide condensed images of all of the chromosomes under study, as well as an expanded view of the ordered graphical representation. Thus, a single chromosome may be selected, e.g., using a cursor, and the graphical representations showing common deletions for that chromosome may be displayed, and analyzed using the methods set forth above.

The subject method includes executing computer-readable instructions that are at a remote location to the user, and transmitting data from the remote location to the graphical user interface at the user's location. In certain embodiments, the data sets may be received from a remote location, and the programming executed locally to the user.

The above-described computer-implemented method may be executed using programming that may be written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as any many others.

Appropriate operating systems for use in conjunction with the programming include, but are not limited to, Solaris (Sun Microsystems, Inc., Santa Clara, Calif.), Windows (Microsoft Corp., Redmond, Wash.), Mac (Apple Computer, Inc., Cupertino, Calif.), or Linux (Red Hat, Inc., Raleigh, N.C.). Appropriate software applications include, but are not limited to, relational databases such as Oracle 9.0.1 (9i) (Oracle Corp., Redwood Shores, Calif.), DB2 Universal Database V8.1 (IBM Corp., Armonk, N.Y.), PostgreSQL (PostgreSQL, Inc., Wolfville, NS Canada), or SQL Server 2000 (Microsoft Corp., Redmond, Wash.).

As noted above, one embodiment involves two tiers of infrastructure: a server tier and a client tier. In one embodiment, the server tier may be an workgroup server (Sun Microsystems, Inc., Santa Clara, Calif.), the operating system may be Solaris (Sun Microsystems, Inc., Santa Clara, Calif.), and the database software may be Oracle 9.0.1 (9i) (Oracle Corp., Redwood Shores, Calif.). In the same embodiment, the client tier may operate using the Windows operating system (Microsoft Corp., Redmond, Wash.). In this embodiment, a Java language-based application, running on the client may contain both business and presentation logic. A Java Runtime Engine (JRE) may interpret and execute the compiled application within the client operating system (e.g. Windows). In addition to proprietary presentation and business logic, the client application may rely on third party application programming interfaces (APIs) for common functionality such as application connectivity and database connectivity. Installing APIs and a database on a server may provide a scalable solution for information sharing and propagating updates among numerous client applications. Each client may communicate with a server-based APIs through the local area network using common protocols (e.g. TCP/IP) supported by both the client and server operating systems (e.g. Windows and Solaris).

### Computer Readable Media

In certain embodiments, the above-described methods are coded onto a computer-readable medium in the form of programming, where the term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer.

In certain embodiments, a computer-readable medium comprising instructions for producing the above-described graphical user interface is provided.

With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

A computer-based system comprising the above-referenced computer readable medium is also provided. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination that will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

One or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Sun Solaris, Linux, OS/400, Compaq Tru64 Unix, SGI IRIX, Siemens Reliant Unix, and others.

In certain embodiments, the subject devices include multiple computer platforms which may provide for certain benefits, e.g., lower costs of deployment, database switching, or changes to enterprise applications, and/or more effective firewalls. Other configurations, however, are possible. For example, as is well known to those of ordinary skill in the relevant art, so-called two-tier or N-tier architectures are possible rather than the three-tier server-side component architecture represented by, for example, E. Roman, Mastering Enterprise JavaBeans™ and the Java™2 Platform (John Wiley & Sons, Inc., NY, 1999) and J. Schneider and R. Arora, Using Enterprise Java. (Que Corporation, Indianapolis, 1997).

It will be understood that many hardware and associated software or firmware components that may be implemented in a server-side architecture for Internet commerce are known and need not be reviewed in detail here. Components to implement one or more firewalls to protect data and applications, uninterruptable power supplies, LAN switches, web-server routing software, and many other components are not shown. Similarly, a variety of computer components customarily included in server-class computing platforms, as well as other types of computers, will be understood to be included but are not shown. These components include, for example, processors, memory units, input/output devices, buses, and other components noted above with respect to a user computer. Those of ordinary skill in the art will readily appreciate how these and other conventional components may be implemented.

The functional elements of system may also be implemented in accordance with a variety of software facilitators and platforms (although it is not precluded that some or all of the functions of system may also be implemented in hardware or firmware). Among the various commercial products available for implementing e-commerce web portals are BEA WebLogic from BEA Systems, which is a so-called “middleware” application. This and other middleware applications are sometimes referred to as “application servers,” but are not to be confused with application server hardware elements. The function of these middleware applications generally is to assist other software components (such as software for performing various functional elements) to share resources and coordinate activities.

Other development products, such as the Java™2 platform from Sun Microsystems, Inc. may be employed in the system to provide suites of applications programming interfaces (API's) that, among other things, enhance the implementation of scalable and secure components. Various other software development approaches or architectures may be used to implement the functional elements of system and their interconnection, as will be appreciated by those of ordinary skill in the art.

Additional system components, methods, arrays and kits may be include as are described in U.S. patent application Ser. No. 11/001,700, filed Nov. 30, 2004, U.S. patent application Ser. No. 11/001,672, filed Nov. 30, 2004 and U.S. patent application Ser. No. 11/000,681, filed Nov. 30, 2004, the entireties of which are incorporated by reference herein.

### Kits

Kits for use in connection with the subject invention may also be provided. Such kits may include at least a computer readable medium including programming as discussed above and instructions. The instructions may include installation or setup directions. The instructions may include directions for use of the invention with options or combinations of options as described above. In certain embodiments, the instructions include both types of information.

Providing the software and instructions as a kit may serve a number of purposes. The combination may be packaged and purchased as a means of upgrading array analysis software. Alternately, the combination may be provided in connection with new software. In certain embodiments, the instructions will serve as a reference manual (or a part thereof) and the computer readable medium as a backup copy to the preloaded utility.

The instructions may be recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or world wide web. Some form of access security or identification protocol may be used to limit access to those entitled to use the subject invention. As with the instructions, the means for obtaining the instructions and/or programming is generally recorded on a suitable recording medium.

### Utility

The nuclear genome of the cells of a plurality of cellular samples may be evaluated using the above-described method. In one embodiment, the method may be employed to identify deletions, insertions, and other chromosomal aberrations, that are common to many different samples.

Arrays employed in CGH assays contain polynucleotides immobilized on a solid support. Array platforms for performing the array-based methods are generally well known in the art (e.g., see Pinkel et al., Nat. Genet. (1998) 20:207-211; Hodgson et al., Nat. Genet. (2001) 29:459-464; Wilhelm et al., Cancer Res. (2002) 62: 957-960) and, as such, need not be described herein in any great detail. In general, CGH arrays contain a plurality (i.e., at least about 100, at least about 500, at least about 1000, at least about 2000, at least about 5000, at least about 10,000, at least about 20,000, usually up to about 100,000 or more) of addressable features that are linked to a planar solid support. Features on a subject array usually contain a polynucleotide that hybridizes with, i.e., binds to, genomic sequences from a cell. Accordingly, such “comparative genome hybridization arrays”, for short “CGH arrays” typically have a plurality of different BACs, cDNAs, oligonucleotides, or inserts from phage or plasmids, etc., that are addressably arrayed. As such, CGH arrays usually contain surface bound polynucleotides that are about 10-200 bases in length, about 201-5000 bases in length, about 5001-50,000 bases in length, or about 50,001-200,000 bases in length, depending on the platform used.

In particular embodiments, CGH arrays containing surface-bound oligonucleotides, i.e., oligonucleotides of 10 to 100 nucleotides and up to 200 nucleotides in length, find particular use in the subject methods.

In general, the subject assays involve labeling a test and a reference genomic sample to make two labeled populations of nucleic acids which may be distinguishably labeled, contacting the labeled populations of nucleic acids with an array of surface bound polynucleotides under specific hybridization conditions, and analyzing any data obtained from hybridization of the nucleic acids to the surface bound polynucleotides. Such methods are generally well known in the art (see, e.g., Pinkel et al., Nat. Genet. (1998) 20:207-211; Hodgson et al., Nat. Genet. (2001) 29:459-464; Wilhelm et al., Cancer Res. (2002) 62: 957-960)) and, as such, need not be described herein in any great detail.

Two different genomic samples may be differentially labeled, where the different genomic samples may include an “experimental” sample, i.e., a sample of interest, and a “control” sample to which the experimental sample may be compared. In certain embodiments, the different samples are pairs of cell types or fractions thereof, one cell type being a cell type of interest, e.g., an abnormal cell, and the other a control, e.g., a normal cell. If two fractions of cells are compared, the fractions are usually the same fraction from each of the two cells. In certain embodiments, however, two fractions of the same cell type may be compared. Exemplary cell type pairs include, for example, cells isolated from a tissue biopsy (e.g., from a tissue having a disease such as colon, breast, prostate, lung, skin cancer, or infected with a pathogen etc.) and normal cells from the same tissue, usually from the same patient; cells grown in tissue culture that are immortal (e.g., cells with a proliferative mutation or an immortalizing transgene), infected with a pathogen, or treated (e.g., with environmental or chemical agents such as peptides, hormones, altered temperature, growth condition, physical stress, cellular transformation, etc.), and a normal cell (e.g., a cell that is otherwise identical to the experimental cell except that it is not immortal, infected, or treated, etc.); a cell isolated from a mammal with a cancer, a disease, a geriatric mammal, or a mammal exposed to a condition, and a cell from a mammal of the same species, preferably from the same family, that is healthy or young; and differentiated cells and non-differentiated cells from the same mammal (e.g., one cell being the progenitor of the other in a mammal, for example). In one embodiment, cells of different types, e.g., neuronal and non-neuronal cells, or cells of different status (e.g., before and after a stimulus on the cells, or in different phases of the cell cycle) may be employed. In another embodiment of the invention, the experimental material is cells susceptible to infection by a pathogen such as a virus, e.g., human immunodeficiency virus (HIV), etc., and the control material is cells resistant to infection by the pathogen. In another embodiment of the invention, the sample pair is represented by undifferentiated cells, e.g., stem cells, and differentiated cells.

Results obtained from several of such array-based CGH assays may be analyzed using the methods described above to identify common aberrations.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A computer-implemented method for viewing comparative genomic hybridization (CGH) data, comprising:
a) inputting a plurality of CGH data sets for a corresponding plurality of genomic samples into a computer memory;
b) analyzing said CGH data sets using an aberration calling method to identify chromosomal regions having aberrant copy number; and
c) producing a graphical user interface that shows graphical representations of a chromosome from each of said genomic samples, said graphical representations showing said chromosomal regions having aberrant copy number.

2. The computer-implemented method of claim 1, wherein said graphical representations of said chromosome are aligned adjacent to each other.

3. The computer-implemented method of claim 1, further comprising executing instructions to identify chromosomal regions having aberrant copy number that are common in said chromosome.

4. The computer-implemented method of claim 3, further comprising indicating said common aberrant regions on said graphical representations of said chromosome.

5. The computer-implemented method of claim 1, wherein said inputting is selecting or uploading.

6. The computer-implemented method of claim 1, wherein the copy number of said chromosomal regions having aberrant copy number is indicated by a color code.

7. The computer-implemented method of claim 1, wherein said method comprises selecting a sub-set of said data sets for showing on said graphical user interface.

8. The computer-implemented method of claim 1, wherein said method includes arranging the order of said graphical representations according to similarities in their regions having aberrant copy number.

9. The computer-implemented method of claim 1, wherein said method includes provides a tree in which said one or more chromosomes are grouped according to similarities in their regions having aberrant copy number.

10. The computer-implemented method of claim 1, wherein said method includes executing computer-readable instructions that are at a remote location to said graphical user interface and transmitting data from said remote location to said graphical user interface.

11. The computer-implemented of claim 1, wherein said method further includes receiving said CGH data sets from a remote location.

12. A computer-readable medium comprising:
instructions for inputting a plurality of CGH data sets for a corresponding plurality of genomic samples into a computer memory;
instructions for analyzing said CGH data sets to identify chromosomal regions having aberrant copy number; and
instructions for producing a graphical user interface that shows graphical representations of a chromosome from each of said genomic samples, said graphical representations showing chromosomal regions having aberrant copy number.

13. The computer-readable medium of claim 12, wherein said graphical representations are aligned next to each other in said graphical user interface.

14. The computer-readable medium of claim 12, further comprising instructions to identify regions of aberrant copy number that are common to said chromosomes.

15. The computer-readable medium of claim 14, further comprising indicating said common regions on said graphical user interface.

16. A computer comprising the computer readable medium of claim 12.

17. The computer of claim 16, further comprising a user interface for inputting a plurality of CGH data sets into a computer memory.

18. A method comprising:
a) performing array-based CGH assays on a plurality of genomic samples to produce a corresponding plurality of CGH data sets;
b) inputting said CGH data sets into a computer of claim 16; and
c) executing said instructions to produce a graphical user interface that shows graphical representations of a chromosome from each of said genomic samples, said graphical representations showing chromosomal regions having aberrant copy number.

19. The method of claim 18, wherein said graphical representations are aligned next to each other in said graphical user interface.

20. The method of claim 18, further comprising executing instructions to identify regions of aberrant copy number that are common to said chromosomes.

21. The method of claim 20, wherein said common regions are indicated on said graphical user interface.
